(19) United States
(12) Patent Application Publication
(10) Pub. No.: US 2024/0015553 A1
(43) Pub. Date: Jan. 11, 2024

(54) ESTIMATING A TOTAL ENERGY CONSUMPTION OF A USER EQUIPMENT

(71) Applicant: Telefonaktiebolaget LM Ericsson (PUBL), Stockholm (SE)

(72) Inventors: Lackis Eleftheriadis, VALBO (SE); Alexandros Nikou, Danderyd (SE); Cecilia Nyström, STOCKHOLM (SE); Kristijonas Cyras, San Jose, CA (US); Marin Orlic, BROMMA (SE)

(21) Appl. No.: 18/252,065

(22) PCT Filed: Nov. 11, 2020
(86) PCT No.: PCT/IB2020/060614

§ 371 Date: May 8, 2023

(51) Int. Cl. H04W 24/10; H04W 24/02; H04W 52/02

(52) U.S. Cl. CPC H04W 24/10; H04W 24/02; H04W 52/0209; H04W 52/0206

(57) ABSTRACT

There is provided a method for estimating a total energy consumption of a user equipment (UE) in a network. The method is performed by a network node. A total energy consumption for the UE is estimated (102) based on a resource usage for the UE and a measure of energy consumed by a base station of the network serving the UE in communicating with the UE. The resource usage for the UE is reported to the network node by the UE and/or the base station, and the measure of energy consumed by the base station is reported to the network node by the UE and/or the base station.

### TECHNICAL FIELD

The disclosure relates to methods for use in estimating a total energy consumption of a user equipment (UE) in a network and nodes configured to operate in accordance with those methods.

### BACKGROUND

With the continuing developments and expansion of telecommunications networks, it is becoming increasingly important to monitor the energy and power consumption (or usage) in such networks. In particular, due to the impact that the energy and power consumption in telecommunications networks can have on the environment, it is important to observe the improvements that can be made to reduce the energy and power consumption in telecommunications networks.

FIGS. 1A and 1B are graphical representations of an estimation of global averages of energy (in Joules) per bit efficiency as a function of time (in years), and an estimation of global averages of power (in Watts) per user equipment efficiency as a function of time (in years) respectively. The improvements that can be made to reduce the energy and power consumption in telecommunications networks can be seen in FIGS. 1A and 1B.

There exist various techniques that are focused on monitoring energy and power consumption in a telecommunications network. In some of these techniques, managed objects with associated performance management (PM) counters are available for accounting the (rolling and accumulated) consumed energy, and also the minimum, maximum and average power consumption. Examples of some PM counters that are available for use in existing monitoring techniques include the following:

pmConsumedEnergy—A counter that measures an energy consumed during each measurement period. The counter is reset after a predefined measurement period. In a protocol data unit inside a base band (BB) controller, the counter evaluates a total energy consumption from all radio units or all of its installed electronic fuses (e-fuses). The measurement unit of the counter is 1 Wh.

pmConsumedEnergyAccumulated—A counter that measures a total energy consumed. The counter is not reset after a predefined measurement period. In a BB controller, the counter evaluates a total energy consumption from all radio units or all of its installed e-fuses. The measurement unit of the counter is 1 Wh.

pmPowerConsumption—A counter that measures an average power consumed during a time window of six seconds. In a BB controller, the counter evaluates a sum of an average power consumption from all radio units or all of its installed e-fuses. The measurement unit of the counter is 1 Wh.

In the existing techniques, the PM counters are available across a subset of the network equipment, such as basebands, radio units and active antenna units. However, the PM counters only provide partial visibility of energy consumption in the network. The PM counters are typically sampled with the granularity of fifteen minutes or less overall, within a single radio base station (RBS) typically with a resolution of one minute.

### SUMMARY

If it is possible for the energy consumption monitoring to become readily available across the entire network, this will result in further derived measures being possible. For example, these further derived measures can include accounting for an environmental footprint, e.g. a carbon footprint that is indicative of carbon dioxide (CO₂) emissions, on a network-level granularity or an even finer granularity. Ideally, monitoring energy consumption at the level of an individual user equipment (UE) is desirable. The goal of bringing the energy consumption monitoring down to a level of an individual UE is to enable additional incentives and mechanisms geared to reduce energy consumption and, in turn, reduce the carbon footprint for the UE. This can be useful in personal carbon trading (PCT) discussions. PCT is a combination of proposed carbon rationing and trading instruments that are discussed in some countries (such as Sweden and the UK) and is aligned with the United Nations Development Programme (UNDP) Sustainable Development Goal (SDG) 13. It is also useful to monitor the energy consumption on the level of an individual UE to be able to provide services offering incentives for reducing energy consumption (and, in turn, the carbon footprint) for each individual UE.

Conceptually, all individuals would receive an annual carbon emissions ‘budget’ for their personal use. This is known in the art as ‘carbon budgeting’. The idea is that an annual carbon emissions budget is to be used to account for emissions under an individual's direct personal control, such as household energy use (electricity and gas), private transport (not including public transport) and aviation, but not including the carbon embedded in products and services purchased by the individual. An individual will be allowed to buy additional emissions or sell their surplus credits in the personal carbon market. At the core of the PCT are the mechanisms of newly established social norms on what is an acceptable personal consumption level, perception and awareness of carbon emissions related to an individual, and economic signals (price and incentives) resulting in a changed economic behaviour. Apart from individuals, the same mechanisms can apply, or already apply in part, to legal entities (e.g. companies and/or enterprises).

However, in the existing techniques, the UE is not informed about the consumption hidden behind a ubiquitous service like a telecommunications network. This opacity may become a rising concern in the future, since it is estimated that a large part of the total information and communication (ICT) carbon footprint is related to serving user devices. Also, the existing techniques for translating from measuring energy to measuring or estimating carbon emissions are complex and indirect because they depend on the carbon intensity of the energy source.

Many people are currently unaware of their personal carbon emissions and might not have an understanding for whether they are a high or low emitter, or to what degree. Ensuring individuals are given actual carbon emissions of the products and services they use in a timely manner and giving both the motivation and the option to make low carbon choices is considered important to make schemes such as PCT work. In addition, utility companies are currently seen as being in a good position to provide tailored advice about reducing emissions as they know the energy consumption of households. This may be expected to extend to other infrastructure in the future, such as the telecommunications infrastructure.

Another aspect of energy efficiency and carbon budgeting pertains to future sixth generation (6G) network deployments. A specific consideration is that there will be energy use in relation to energy reuse factors when considering the RBS infrastructure. In particular, radio units produce a large amount of heat, which is currently wasted, but which can be reused in future 6G systems. For example, energy usage factors are related to power consumption usage of baseband (BB) and radio units. In contrast to this, the energy reuse factor of BB and radio units is related to the regenerated energy returned to the system.

There have been metrics designed to show the energy per transferred bit, which is representative of an efficiency of a coding scheme used in a network. However, the energy per transferred bit does not correspond well to an energy usage per UE. The additional efficiency is achieved with other changes in the network. It is also envisioned that, in the future, 6G deployments will increase the effect of an overall energy reduction per UE efficiency.

It is thus an object of the disclosure to obviate or eliminate at least some of the above-described disadvantages associated with existing techniques.

Therefore, according to an aspect of the disclosure, a method for estimating a total energy consumption of a user equipment (UE) in a network is provided. The method is performed by a network node. The method comprises estimating a total energy consumption for the UE based on a resource usage for the UE and a measure of energy consumed by a base station of the network serving the UE in communicating with the UE. The resource usage for the UE is reported to the network node by the UE and/or the base station, and the measure of energy consumed by the base station is reported to the network node by the UE and/or the base station.

In this way, an advantageous technique for estimating a total energy consumption of a UE in a network is provided. The technique is improved over existing techniques since it allows for a reliable estimation of the total energy consumption at various levels that include UE level (i.e. the estimation of the total energy consumption per UE). This finer granularity allows for improved visibility of the energy consumption in the network, which can be useful in enabling additional incentives and mechanisms geared to reducing energy consumption for the UE and, in turn, the carbon footprint for the UE.

In some embodiments, the method may comprise initiating rendering, at the UE, of any one or more of the resource usage for the UE, the measure of energy consumed by the base station, and the estimated total energy consumption for the UE.

In some embodiments, the method may comprise initiating rendering, at the UE, of the estimated total energy consumption for the UE with a corresponding total energy consumption for a reference activity that has an associated carbon footprint.

In some embodiments, the method may comprise generating a model to predict a future total energy consumption for the UE, wherein the model is generated using the estimated total energy consumption for the UE, the resource usage for the UE, and the measure of energy consumed by the base station.

In some embodiments, generating the model to predict the future total energy consumption for the UE may comprise compiling a look-up table to predict the future total energy consumption for the UE or training a machine learning model to predict the future total energy consumption for the UE.

In some embodiments, the method may comprise estimating a carbon footprint for the UE based on the estimated total energy consumption for the UE.

In some embodiments, the method may comprise estimating the carbon footprint for the UE based on the estimated total energy consumption for the UE and an emission factor for one or more energy sources powering the base station.

In some embodiments, the method may comprise initiating rendering, at the UE, of the estimated carbon footprint for the UE.

In some embodiments, the method may comprise initiating rendering, at the UE, of the estimated carbon footprint for the UE with a carbon footprint for a reference activity.

In some embodiments, the method may comprise controlling one or more network orchestrators based on the estimated carbon footprint for the UE and/or controlling network slice construction, composition and/or deployment based on the estimated carbon footprint for the UE.

In some embodiments, the method may comprise generating a model to predict a future carbon footprint for the UE, wherein the model is generated using the estimated carbon footprint for the UE and the estimated total energy consumption for the UE.

In some embodiments, the model may be generated using a predicted emission factor for one or more energy sources powering the base station.

In some embodiments, generating the model to predict the future carbon footprint for the UE may comprise compiling a look-up table to predict the future carbon footprint for the UE or training a machine learning model to predict the future carbon footprint for the UE.

In some embodiments, the method may comprise determining an efficiency factor indicative of an efficiency of the base station when serving the UE.

In some embodiments, the efficiency factor may be determined based on measurement data acquired on the base station during development of the base station and/or testing of the base station and/or operational data acquired on the base station during deployment of the base station in the network.

In some embodiments, the efficiency factor may be determined using a statistical and/or machine learning process.

In some embodiments, the method may comprise estimating changes in the total energy consumption for the UE based on periodic changes in the resource usage for the UE in the network and/or periodic changes in the measure of energy consumed by the base station in communicating with the UE, wherein the periodic changes in the resource usage for the UE may be reported to the network node by the UE and/or the base station, and the periodic changes in the measure of energy consumed by the base station is reported to the network node by the UE and/or the base station.

In some embodiments, the method may comprise initiating rendering, at the UE, of the estimated changes in the total energy consumption for the UE.

In some embodiments, the method may comprise initiating rendering, at the UE, of the estimated changes in the total energy consumption of the UE with corresponding changes in the total energy consumption for a reference activity that has an associated carbon footprint.

In some embodiments, the method may comprise estimating changes in a carbon footprint for the UE based on the estimated changes in the total energy consumption for the UE.

In some embodiments, the method may comprise estimating the changes in the carbon footprint for the UE based on the estimated changes in the total energy consumption for the UE and/or changes in an emission factor for the one or more energy sources powering the base station.

In some embodiments, the method may comprise initiating rendering, at the UE, of the estimated changes in the carbon footprint for the UE.

In some embodiments, the method may comprise initiating rendering, at the UE, of the estimated changes in the carbon footprint for the UE with corresponding changes in a carbon footprint for a reference activity.

In some embodiments, the resource usage for the UE may be the number of resources in use by the UE.

In some embodiments, the measure of energy consumed by the base station may be reported at the end of a call involving the UE, as part of a data transfer, and/or during handover of the UE from the base station to another base station.

In some embodiments, estimating the total energy consumption for the UE may comprise estimating the total energy consumption for the UE based on the resource usage for the UE, the measure of energy consumed by the base station, and a measure of energy reused by the base station, wherein the measure of energy reused by the base station may be reported to the network node by the base station.

In some embodiments, the method may be performed for a plurality of UEs in the network.

According to another aspect of the disclosure, there is provided a network node configured to operate in accordance with the method described earlier in respect of the network node. The network node thus provides the advantages described earlier.

In some embodiments, the network node may comprise processing circuitry configured to operate in accordance with the method described earlier in respect of the network node.

In some embodiments, the network node may comprise at least one memory for storing instructions which, when executed by the processing circuitry, cause the network node to operate in accordance with the method described earlier in respect of the network node.

According to another aspect of the disclosure, there is provided a method for use in estimating an energy consumption for UE in a network. The method is performed by a base station of the network that is serving the UE. The method comprises reporting, to a network node, a resource usage for the UE and/or a measure of energy consumed by the base station in communicating with the UE. The resource usage for the UE is for use, with the measure of energy consumed by the base station, in estimating a total energy consumption for the UE. The method thus provides the advantages described earlier.

In some embodiments, the resource usage for the UE may be the number of resources in use by the UE.

In some embodiments, the base station may comprise a counter configured to measure the energy consumed by the base station and the measure of energy consumed by the base station is acquired from the counter.

In some embodiments, the measure of energy consumed by the base station may be reported at the end of a call involving the UE, as part of a data transfer, and/or during handover of the UE from the base station to another base station.

In some embodiments, the method may comprise reporting, to the network node, a measure of energy reused by the base station.

In some embodiments, the method may comprise reporting, to the network node, periodic changes in the resource usage for the UE in the network and/or periodic changes in the measure of energy consumed by the base station in communicating with the UE, wherein the periodic changes in the resource usage for the UE are for use, with the periodic changes in the measure of energy consumed by the base station, in estimating changes in the total energy consumption for the UE.

In some embodiments, the method may be performed for a plurality of UEs in the network.

According to another aspect of the disclosure, there is provided a base station configured to operate in accordance with the method described earlier in respect of the base station. The base station thus provides the advantages described earlier.

In some embodiments, the base station may comprise processing circuitry configured to operate in accordance with the method described earlier in respect of the base station.

In some embodiments, the base station may comprise at least one memory for storing instructions which, when executed by the processing circuitry, cause the base station to operate in accordance with the method described earlier in respect of the base station.

According to another aspect of the disclosure, there is provided a method for use in estimating an energy consumption for a UE in a network. The method is performed by the UE. The method comprises reporting, to a network node, a measure of energy consumed by a base station of the network serving the UE in communicating with the UE and/or a resource usage for the UE. The measure of energy consumed by the base station is for use, with the resource usage for the UE, in estimating a total energy consumption for the UE. The method thus provides the advantages described earlier.

In some embodiments, the resource usage for the UE may be the number of resources in use by the UE.

In some embodiments, the UE may comprise a counter configured to measure the energy consumed by the base station and the measure of energy consumed is acquired from the counter.

In some embodiments, the measure of energy consumed by the base station may be reported at the end of a call involving the UE, as part of a data transfer, and/or during handover of the UE from the base station to another base station.

In some embodiments, the method may comprise reporting, to the network node, periodic changes in the measure of energy consumed by the base station in communicating with the UE and/or periodic changes in the resource usage for the UE, wherein the periodic changes in the measure of energy consumed by the base station is for use, with the periodic changes in the resource usage for the UE, in estimating changes in the total energy consumption for the UE.

According to another aspect of the disclosure, there is provided a UE configured to operate in accordance with the method described earlier in respect of the UE. The UE thus provides the advantages described earlier.

In some embodiments, the UE may comprise processing circuitry configured to operate in accordance with the method described earlier in respect of the UE.

In some embodiments, the UE may comprise at least one memory for storing instructions which, when executed by the processing circuitry, cause the UE to operate in accordance with the method described earlier in respect of the UE.

According to another aspect of the disclosure, there is provided another method for estimating a total energy consumption for a UE in a network. The method is performed by a system. The method comprises the method described earlier in respect of the network node, the method described earlier in respect of the base station, and/or the method described earlier in respect of the UE. The method thus provides the advantages described earlier.

According to another aspect of the disclosure, there is provided a system for estimating a total energy consumption for a UE in a network. The system comprises at least one network node as described earlier, at least one base station as described earlier, and/or at least one UE as described earlier. The system thus provides the advantages described earlier.

According to another aspect of the disclosure, there is provided a computer program comprising instructions which, when executed by processing circuitry, cause the processing circuitry to perform the method described earlier in respect of the network node, the base station and/or the UE. The computer program thus provides the advantages described earlier.

According to another aspect of the disclosure, there is provided a computer program product, embodied on a non-transitory machine-readable medium, comprising instructions which are executable by processing circuitry to cause the processing circuitry to perform the method described earlier in respect of the network node, the base station and/or the UE. The computer program product thus provides the advantages described earlier.

Therefore, an advantageous technique for estimating a total energy consumption of a UE in a network is provided.

### BRIEF DESCRIPTION OF THE DRAWINGS

For a better understanding of the techniques, and to show how they may be put into effect, reference will now be made, by way of example, to the accompanying drawings, in which:

FIG. 1A is a graphical representation of an estimation of global averages of energy per bit efficiency as a function of time;

FIG. 1B is a graphical representation of an estimation of global averages of power per user equipment efficiency as a function of time;

FIG. 2 is a block diagram illustrating a network node according to an embodiment;

FIG. 3 is a flowchart illustrating a method performed by a network node according to an embodiment;

FIG. 4 is a schematic illustrating resources used by a user equipment;

FIG. 5 is a signalling diagram illustrating an exchange of signals in a system according to an embodiment;

FIG. 6 is a signalling diagram illustrating an exchange of signals in a system according to an embodiment;

FIG. 7 is a block diagram illustrating a base station according to an embodiment;

FIG. 8 is a flowchart illustrating a method performed by a base station according to an embodiment;

FIG. 9 is a block diagram illustrating a user equipment according to an embodiment;

FIG. 10 is a flowchart illustrating a method performed by a user equipment according to an embodiment;

FIG. 11 is a schematic illustrating a network according to an embodiment;

FIG. 12 is a schematic illustrating a user equipment according to an embodiment; and

FIG. 13 is schematic illustrating a virtualization environment according to an embodiment.

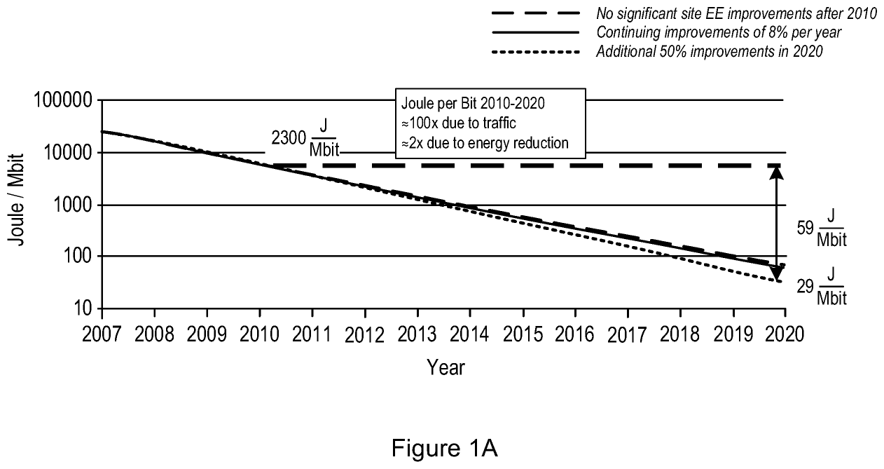

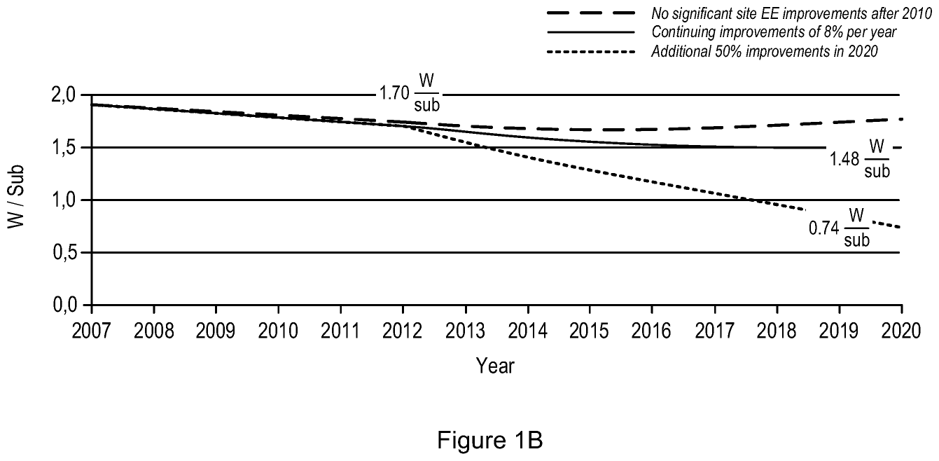

### DETAILED DESCRIPTION

Some of the embodiments contemplated herein will now be described more fully with reference to the accompanying drawings. Other embodiments, however, are contained within the scope of the subject-matter disclosed herein, the disclosed subject-matter should not be construed as limited to only the embodiments set forth herein; rather, these embodiments are provided by way of example to convey the scope of the subject-matter to those skilled in the art.

As mentioned earlier, an advantageous technique for estimating a total energy consumption of a user equipment (UE) in a network is described herein. The network referred to herein can be a telecommunications network, such as a cellular or mobile network. The network referred to herein can be any generation of network, such as a fourth generation (4G) network, a fifth generation (5G) network, a sixth generation (6G) network, or any other generation network. The network referred to herein may, for example, be a radio access network (RAN), or any other type of telecommunications network. The network referred to herein can comprise one or more base stations. The one or more base stations can be for use in connecting the UE to the network. In a RAN embodiment, the one or more base stations may comprise one or more evolved Node Bs (eNodeBs) and/or any other RAN nodes. In some embodiments, the network referred to herein can be a virtualized network (e.g. comprising virtual network nodes), an at least partially virtualized network (e.g. comprising at least some virtual network nodes and at least some hardware network nodes), or a hardware network (e.g. comprising hardware network nodes).

A part of the method described herein can be implemented by a network node. Another part of the method described herein can be implemented by a base station and/or a UE.

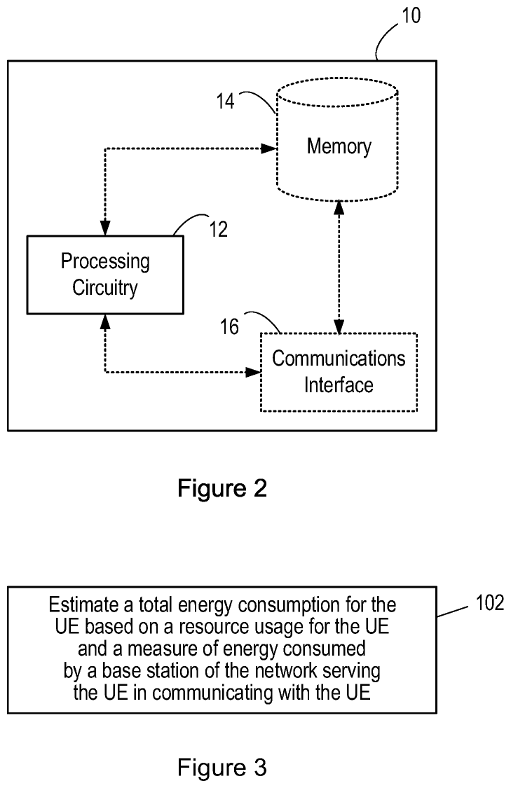

FIG. 2 illustrates a network node 10 in accordance with an embodiment. The network node 10 is for estimating a total energy consumption of a UE in a network. In some embodiments, the network can comprise the network node 10. In other embodiments, the network node 10 may be external to the network.

In some embodiments, the network node 10 referred to herein may be a network node of a network operations center (NOC) or a core network. In some embodiments, the network node 10 referred to herein may implement the method described herein using a network manager (NM). The network node 10 referred to herein can refer to equipment capable, configured, arranged and/or operable to communicate directly or indirectly with a UE, a base station, and/or with other network nodes or equipment to enable and/or to perform the functionality described herein. The network node 10 referred to herein may be a physical network node (e.g. a physical machine) or a virtual network node (e.g. a virtual machine, VM) as described in more detail later.

Examples of network nodes include, but are not limited to, servers, access points (APs) (e.g. radio access points), base stations (BSs) (e.g. radio base stations, Node Bs, evolved Node Bs (eNBs) and New Radio (NR) NodeBs (gNBs)). The network node 10 referred to herein may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g. MSCs, MMEs), Operation and Maintenance (O&M) nodes, Operations Support System (OSS) nodes, Self-Optimized Network (SON) nodes, positioning nodes (e.g. evolved Serving Mobile Location Centers, E-SMLCs), and/or Minimization of Drive Tests (MDTs). More generally, however, network nodes may represent any suitable device (or group of devices) capable, configured, arranged, and/or operable to enable and/or provide the functionality described herein.

As illustrated in FIG. 2, the network node 10 comprises processing circuitry (or logic) 12. The processing circuitry 12 controls the operation of the network node 10 and can implement the method described herein in respect of the network node 10. The processing circuitry 12 can be configured or programmed to control the network node 10 in the manner described herein. The processing circuitry 12 can comprise one or more hardware components, such as one or more processors, one or more processing units, one or more multi-core processors and/or one or more modules. In particular implementations, each of the one or more hardware components can be configured to perform, or is for performing, individual or multiple steps of the method described herein in respect of the network node 10. In some embodiments, the processing circuitry 12 can be configured to run software to perform the method described herein in respect of the network node 10. The software may be containerised according to some embodiments. Thus, in some embodiments, the processing circuitry 12 may be configured to run a container to perform the method described herein in respect of the network node 10.

Briefly, the processing circuitry 12 of the network node 10 is configured to estimate a total energy consumption for the UE based on a resource usage for the UE and a measure of energy consumed by a base station of the network serving the UE in communicating with the UE. The resource usage for the UE is reported to the network node by the UE and/or the base station, and the measure of energy consumed by the base station is reported to the network node by the UE and/or the base station.

As illustrated in FIG. 2, in some embodiments, the network node 10 may optionally comprise a memory 14. The memory 14 of the network node 10 can comprise a volatile memory or a non-volatile memory. In some embodiments, the memory 14 of the network node 10 may comprise a non-transitory media. Examples of the memory 14 of the network node 10 include, but are not limited to, a random access memory (RAM), a read only memory (ROM), a mass storage media such as a hard disk, a removable storage media such as a compact disk (CD) or a digital video disk (DVD), and/or any other memory.

The processing circuitry 12 of the network node 10 can be connected to the memory 14 of the network node 10. In some embodiments, the memory 14 of the network node 10 may be for storing program code or instructions which, when executed by the processing circuitry 12 of the network node 10, cause the network node 10 to operate in the manner described herein in respect of the network node 10. For example, in some embodiments, the memory 14 of the network node 10 may be configured to store program code or instructions that can be executed by the processing circuitry 12 of the network node 10 to cause the network node 10 to operate in accordance with the method described herein in respect of the network node 10. Alternatively or in addition, the memory 14 of the network node 10 can be configured to store any information, data, messages, requests, responses, indications, notifications, signals, or similar, that are described herein. The processing circuitry 12 of the network node 10 may be configured to control the memory 14 of the network node 10 to store information, data, messages, requests, responses, indications, notifications, signals, or similar, that are described herein.

In some embodiments, as illustrated in FIG. 2, the network node 10 may optionally comprise a communications interface 16. The communications interface 16 of the network node 10 can be connected to the processing circuitry 12 of the network node 10 and/or the memory 14 of network node 10. The communications interface 16 of the network node 10 may be operable to allow the processing circuitry 12 of the network node 10 to communicate with the memory 14 of the network node 10 and/or vice versa. Similarly, the communications interface 16 of the network node 10 may be operable to allow the processing circuitry 12 of the network node 10 to communicate with the base station referred to herein, the UE referred to herein, any other entities referred to herein, and/or any nodes referred to herein. The communications interface 16 of the network node 10 can be configured to transmit and/or receive information, data, messages, requests, responses, indications, notifications, signals, or similar, that are described herein. In some embodiments, the processing circuitry 12 of the network node 10 may be configured to control the communications interface 16 of the network node 10 to transmit and/or receive information, data, messages, requests, responses, indications, notifications, signals, or similar, that are described herein.

Although the network node 10 is illustrated in FIG. 2 as comprising a single memory 14, it will be appreciated that the network node 10 may comprise at least one memory (i.e. a single memory or a plurality of memories) 14 that operate in the manner described herein. Similarly, although the network node 10 is illustrated in FIG. 2 as comprising a single communications interface 16, it will be appreciated that the network node 10 may comprise at least one communications interface (i.e. a single communications interface or a plurality of communications interface) 16 that operate in the manner described herein. It will also be appreciated that FIG. 2 only shows the components required to illustrate an embodiment of the network node 10 and, in practical implementations, the network node 10 may comprise additional or alternative components to those shown.

FIG. 3 is a flowchart illustrating a method performed by a network node 10 in accordance with an embodiment. The method is for estimating a total energy consumption of a UE in a network. The network node 10 described earlier with reference to FIG. 2 can be configured to operate in accordance with the method of FIG. 3. The method can be performed by or under the control of the processing circuitry 12 of the network node 10 according to some embodiments.

With reference to FIG. 3, as illustrated at block 102, a total energy consumption for the UE is estimated based on a resource usage for the UE and a measure of energy consumed by a base station of the network serving the UE in communicating with the UE. More specifically, the processing circuitry 12 of the network node 10 can estimate the total energy consumption for the UE in this way according to some embodiments. Thus, the resource usage and the measure of energy consumed by the base station is for a certain UE, such that the total energy consumption can be estimated per UE (i.e. at UE level). The base station is the current base station, i.e. the base station that is currently serving the UE. The measure of energy consumed by the base station may also be referred to as the communication energy with the base station. The communication energy with the base station correlates to (or provides an indication of) usage on the network side.

In some embodiments, estimating the total energy consumption for the UE may comprise calculating a sum of a dynamic energy consumption for the UE from the resource usage for the UE and a sum of a static energy consumption for the UE from the measure of energy consumed by the base station serving the UE. The dynamic energy consumption for the UE may be calculated as the fraction of the total resources used to communicate with all UEs attached to the base station serving the UE that are used to communication with the UE. The static energy consumption for the UE may be calculated by dividing the measure of energy consumed by the base station serving the UE by the number of UEs attached to that base station.

In some embodiments, the resource usage for the UE referred to herein may be the number of resources in use by the UE. The total power supplied to the base station may also be referred to as the total incoming power for the base station. Herein, the resource usage for the UE may, for example, be the physical resource block (PRB) usage for the UE. For example, the resource usage for the UE may be the number of PRBs in use by the UE. In some embodiments, estimating the total energy consumption for the UE based on the resource usage for the UE may comprise estimating the resource usage for the UE as a percentage of a total power supplied to the base station or as a percentage of the total number of resources used by all UEs.

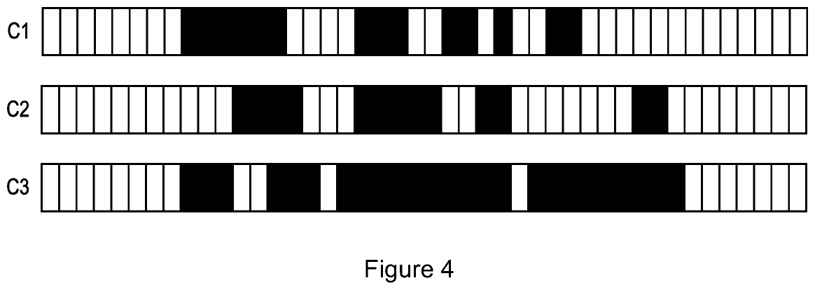

FIG. 4 illustrates an example of such PRBs in use by the UE. In the example illustrated in FIG. 4, there are three carriers (C1, C2, C3) with PRBs that are used by the UE. However, it will be understood that there may be any other number (e.g. one or more) carriers with PRBs that are used by the UE in other examples. It will also be understood that, although PRBs have been provided as an example, the resource usage for the UE can also or instead include any other type of resource and any combination of resources used by the UE.

The resource usage for the UE is reported to the network node 10 by the UE and/or the base station, and the measure of energy consumed by the base station is reported to the network node 10 by the UE and/or the base station. In some embodiments, the method may comprise receiving information indicative of the resource usage for the UE and the measure of energy consumed by the base station. More specifically, the processing circuitry 12 of the network node 10 may be configured to receive this information (e.g. via the communications interface 16 of the network node 10) according to some embodiments. In some embodiments involving counters, the information may be received from one or more counters. In some embodiments, the information may be stored at the one or more counters. In some embodiments, the measure of energy consumed by the base station may be reported at the end of a call involving the UE, as part of a data transfer (e.g. transfer of a traffic usage report), and/or during handover of the UE from the base station to another base station (which may also be referred to as cell handover). In some embodiments, the measure of energy consumed by the base station may be reported periodically.

In some embodiments, estimating the total energy consumption for the UE may comprise estimating the total energy consumption for the UE based on the resource usage for the UE, the measure of energy consumed by the base station, and a measure of the energy reused by the base station. The measure of energy reused by the base station may be reported to the network node 10 by the base station 20. In some embodiments, the method may comprise receiving information indicative of the measure of energy reused by the base station and/or UE. More specifically, the processing circuitry 12 of the network node 10 may be configured to receive this information (e.g. via the communications interface 16 of the network node 10) according to some embodiments. In some embodiments involving counters, the information may be received from one or more counters. In some embodiments, the information may be stored at the one or more counters.

The measure of the energy reused by the base station can be a measure of waste energy that is used (e.g. harvested for reuse) by the base station in communicating with the UE. An example of waste energy includes waste heat from one or more components of the base station, and the reuse in this example may be accomplished by harvesting waste energy with thermogalvanic cells. However, other examples are also possible. Herein, the measure of the energy reused by the base station may also be referred to as an energy reuse factor of the base station. The energy reuse factor for the base station may be used in the estimation of the total energy consumption for the UE by adjusting (or, more specifically) decreasing the estimated total energy consumption for the UE. For example, if the base station reused a certain amount of energy, the total energy consumption for the UE may be decreased by this amount.

Although not illustrated in FIG. 3, in some embodiments, the method may comprise initiating rendering, at the UE, of any one or more of the resource usage for the UE, the measure of energy consumed by the base station, and the estimated total energy consumption for the UE. In some embodiments, the method may comprise initiating rendering, at the UE, of the estimated total energy consumption for the UE with a corresponding total energy consumption for a reference activity that has an associated carbon footprint. More specifically, the processing circuitry 12 of the network node 10 may be configured to initiate (e.g. via the communications interface 16 of the network node 10) any of this rendering at the UE according to some embodiments. The rendering, at the UE, of the estimated total energy consumption for the UE with a corresponding total energy consumption for a reference activity provides the UE with feedback on the direct CO₂ impact. The reference activity can be an activity having well-recognised statistics (i.e. an activity that is well-recognised by a user of the UE), such as driving or flying. In this way, it is possible for a user of the UE to understand the extent of their energy consumption, compared to the energy consumption of an activity that they are familiar with. By reporting the results of the method described herein in comparison to a reference activity, it is possible to increase the understanding of telecommunications effects. Effectively, the total energy consumption for the reference activity puts the estimated total energy consumption for the UE into context. Herein, any references to rendering at the UE can include displaying at the UE, such as on a screen of the UE.

Although also not illustrated in FIG. 3, in some embodiments, the method may comprise generating a model to predict a future total energy consumption for the UE. More specifically, the processing circuitry 12 of the network node 10 may be configured to generate this model according to some embodiments. The model can be generated using the estimated total energy consumption for the UE, the resource usage for the UE, and the measure of energy consumed by the base station. In some embodiments, generating the model to predict the future total energy consumption for the UE may comprise compiling a look-up table to predict the future total energy consumption for the UE or training a machine learning model to predict the future total energy consumption for the UE. The prediction of the future total energy consumption for the UE from this model can be useful for reducing energy consumption in the network.

In the machine learning embodiments, the estimated total energy consumption for the UE provides the (ground truth) output for the machine learning model, and the resource usage for the UE and the measure of energy consumed by the base station provide the corresponding inputs for the machine learning model for use in training the machine learning model to predict the future total energy consumption for the UE. The training data used to train the machine learning model can thus comprise the estimated total energy consumption for the UE, the resource usage for the UE, and the measure of energy consumed by the base station. The machine learning model can learn a mapping between the inputs and the (ground truth) output. In this way, when an input is subsequently provided to the trained machine learning model, the trained machine learning model is able to predict a corresponding output. In some machine learning embodiments, the machine learning model that is trained to predict the future total energy consumption for the UE can be a long-short term memory (LSTM) model, or any other applicable machine learning model.

In some embodiments, the method can comprise using the model (e.g. the compiled look-up table and/or the trained machine learning model) to predict a future total energy consumption for the UE. More specifically, the processing circuitry 12 of the network node 10 may be configured to use the model to make this prediction according to some embodiments. In the look-up table embodiments, using the model can comprise looking up a resource usage for a UE and/or a measure of energy consumed by a base station serving the UE in communicating with the UE in the look-up table to identify a corresponding total energy consumption. In the machine learning embodiments, using the model can comprise inputting into the trained machine learning model a resource usage for a UE and a measure of energy consumed by a base station serving the UE in communicating with the UE. The output of the trained machine learning model is then the predicted future total energy consumption for the UE.

Although also not illustrated in FIG. 3, in some embodiments, the method may comprise estimating (and, for example, storing) a carbon footprint for the UE based on the estimated total energy consumption for the UE. More specifically, the processing circuitry 12 of the network node 10 may be configured to estimate the carbon footprint for the UE in the manner described according to some embodiments. Herein, the carbon footprint for the UE can be defined as an amount (or level, e.g. number of grams) of carbon dioxide (CO₂) emitted (or released) into the atmosphere as a result of the activities of the UE. Thus, the carbon footprint referred to herein may be an amount of CO₂ emissions for the UE. The carbon footprint (or, more specifically, the CO₂ consumption) for the UE is proportional to the total energy consumption for the UE.

In some embodiments, the method may comprise estimating the carbon footprint for the UE based on the estimated total energy consumption for the UE and an emission factor for one or more energy sources (e.g. power supplies) powering the base station, such as any one or more of a (e.g. smart) grid, a battery, a diesel generator, a solar panel, a wind turbine, a power harvester (e.g. that reuses excess heat), and/or any other energy source that may be powering the base station. The emission factor for an energy source can be defined as the amount (e.g. number of grams) of carbon dioxide (CO₂) emitted by the energy source in powering the base station per unit of energy used by the energy source to power the base station. In some embodiments, an energy source may itself provide the emission factor for use in the estimation of the total energy consumption for the UE. In other embodiments, the emission factor may be measured, determined and/or learnt, such as by the network node 10 (or, more specifically, the processing circuitry 12 of the network node 10) or any other network node. The emission factor may also be referred to as an emission coefficient or an energy source CO₂ emission factor (SCF).

In some embodiments where a plurality of energy sources power the base station, the emission factor (SCF) may be determined using the following equation:

SCF=sum(energy_share_i*SCFᵢ),

where the sum is over all energy sources (e.g. 1 to i) powering the base station and the energy_share_i is the ratio of the energy from energy source “i” in the total energy consumption. In this way, with a mixed energy source, the carbon footprint for the UE can be estimated dynamically by taking into account the emission factor.

In an example of determining the emission factor (SCF), if the base station gets 80% of its energy from a first energy source (e.g. the grid) where the emission factor (SCF1) is measured as 50 gCO₂/kWh and 20% of its energy from a second energy source (e.g. solar power) where the emission factor (SCF2) is measured as 0 gCO₂/kWh, then the overall emission factor (SCF) is 40 gCO₂/kWh, since SCF=80%*SCF1+20%*SCF2=40 gCO2/kWh. In another example of determining the emission factor (SCF), if the base station gets 40% of its energy from a first energy source where the emission factor (SCF1) is measured as 100 gCO₂/kWh and 60% of its energy from a second energy source where the emission factor (SCF2) is measured as 20 gCO₂/kWh, the overall emission factor (SCF) is 52 gCO₂/kWh, since SCF=40%*SCF1+60%*SCF2=52 gCO₂/kWh. The emission factor (SCF) may change over time.

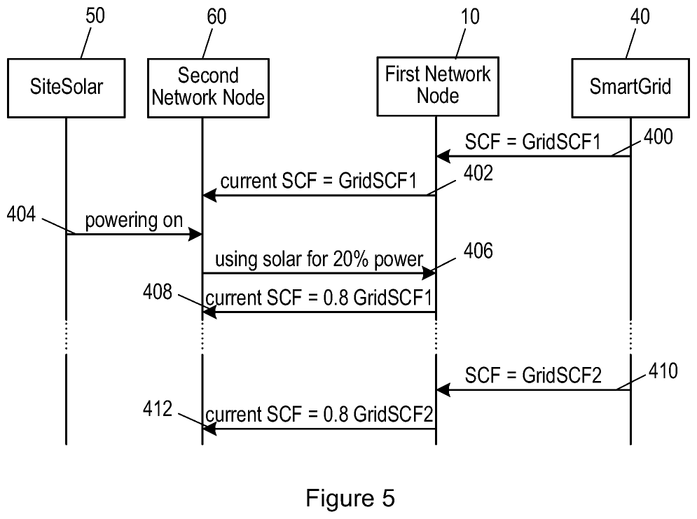

FIG. 5 is a signalling diagram illustrating an exchange of signals in a system according to an embodiment. The system illustrated in FIG. 5 comprises the network node 10 referred to herein, which will be referred to as the first network node 10, and another network node 60, which will be referred to as the second network node 60. In more detail, FIG. 5 illustrates the exchange of signals involved in determining the emission factor (SCF) for one or more energy sources powering the base station 20 (which is not illustrated in FIG. 5) in this embodiment. The embodiment of FIG. 5 illustrates that the calculation of the SCF can be distributed, e.g. over a plurality of network nodes that can comprise the first network node 10 and the second network node 60. The first network node 10 and the second network node 60 may be located on the edge of the network or centrally in the network.

As illustrated by arrow 400 of FIG. 5, a (e.g. smart) grid 40 transmits information indicative of an SCF for the grid 40 (SCF1) towards the first network node 10. Thus, the first network node 10 receives the information indicative of SCF1. The grid 40 is an energy source powering the base station 20. As illustrated by arrow 402 of FIG. 5, the first network node 10 may transmit the information indicative of SCF1 towards the second network node 60 to inform the second network node 60 that this is the current SCF.

As illustrated by arrow 404 of FIG. 5, a renewable energy source (e.g. a solar panel) 50 begins to power the base station 20 and the second network node 60 is informed of this. As such, the second network node 60 has information on this other energy source and can report this to the first network node 10 for use by the first network node 10 in calculating an overall SCF. Thus, as illustrated by arrow 406 of FIG. 5, the second network node 60 transmits information indicative of the percentage of the energy powering the base station 20 that is from this renewable energy source 50. The first network node 10 receives the information indicative of the percentage of the energy powering the base station 20 that is from the renewable energy source 50. In the illustrated embodiment, this percentage is 20% (but any other percentage is also possible).

As illustrated by arrow 408 of FIG. 5, the first network node 10 may transmit information indicative of an overall SCF towards the second network node 60 to inform the second network node 60 that this is the current SCF. In the illustrated embodiment, as the percentage of the energy from the renewable energy source 50 powering the base station 20 is 20%, the overall SCF is 0.8 of SCF1. As illustrated by arrow 410 of Figure the grid 40 may transmit information indicative of an updated SCF for the grid 40 (SCF2) towards the first network node 10. Thus, the first network node 10 receives the information indicative of SCF2 for the grid 40. As illustrated by arrow 412 of FIG. 5, the first network node 10 may transmit information indicative of an updated overall SCF towards the second network node 60 to inform the second network node 60 that this is the current SCF. As the percentage of the energy from the renewable energy source 50 powering the base station 20 is still 20%, the updated overall SCF that is transmitted to the second network node 60 is 0.8 of SCF2. The process may be repeated each time there is an update from the one or more energy sources 40, 50.

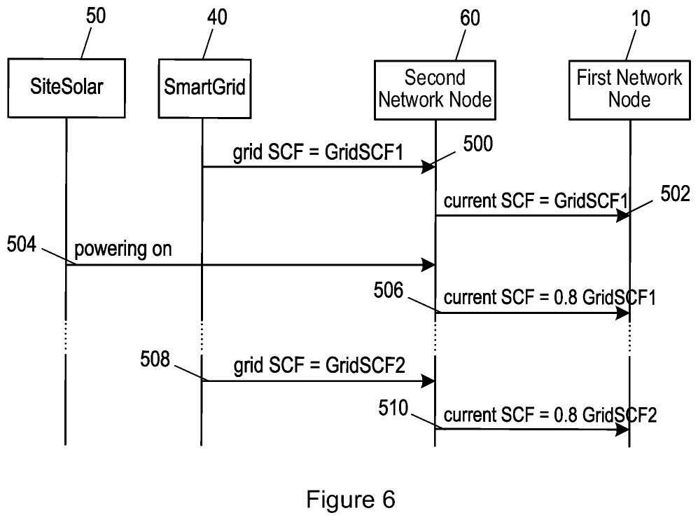

FIG. 6 is a signalling diagram illustrating an exchange of signals in a system according to another embodiment. The system illustrated in FIG. 6 comprises the network node referred to herein, which will be referred to as the first network node 10, and another network node 60, which will be referred to as the second network node 60. In more detail, FIG. 6 illustrates the exchange of signals involved in determining the emission factor (SCF) for one or more energy sources powering the base station 20 in this embodiment. In the embodiment illustrated in FIG. 6, any update to the SCF is calculated at the second network node 60 and reported to the first network node 10. The embodiment of FIG. 6 illustrates that the calculation of the SCF can be distributed, e.g.

over a plurality of network nodes that can comprise the first network node 10 and the second network node 60. The first network node 10 and the second network node 60 may be located on the edge of the network or centrally in the network.

As illustrated by arrow 500 of FIG. 6, a (e.g. smart) grid 40 transmits information indicative of an SCF for the grid 40 (SCF1) towards the second network node 60. Thus, the second network node 60 receives the information indicative of the initial SCF for the grid 40. The grid 40 is an energy source powering the base station 20. As illustrated by arrow 502 of FIG. 6, the second network node 60 may transmit the information indicative of SCF1 towards the first network node 10 to inform the first network node 10 that this is the current SCF.

As illustrated by arrow 504 of FIG. 6, a renewable energy source (e.g. a solar panel) 50 begins to power the base station 20 and the second network node 60 is informed of this. As illustrated by arrow 506 of FIG. 6, in response to this, the second network node 60 transmits information indicative of an overall SCF towards the first network node 10 to inform the first network node 10 that this is the current SCF. In the illustrated embodiment, as the percentage of the energy from the renewable energy source 50 powering the base station 20 is 20%, the overall SCF is 0.8 of SCF1.

As illustrated by arrow 508 of FIG. 6, the grid 40 may transmit information indicative of an updated SCF for the grid 40 (SCF2) towards the second network node 60. Thus, the second network node 60 receives the information indicative of SCF2. As illustrated by arrow 510 of FIG. 6, the second network node 60 may transmit information indicative an updated overall SCF towards the first network node 10 to inform the first network node that this is the current SCF. As the percentage of the energy from the renewable energy source 50 powering the base station 20 is still 20%, the updated overall SCF that is transmitted to the first network node 10 is 0.8 of SCF2. The process may be repeated each time there is an update from the one or more energy sources 40, 50.

Thus, in the manner described, a carbon footprint for the UE can be estimated. Although not illustrated in FIG. 3, in some of embodiments, the method may comprise initiating rendering, at the UE, of the estimated carbon footprint for the UE. In some embodiments, the method may comprise initiating rendering, at the UE, of the estimated carbon footprint for the UE with a carbon footprint for a reference activity. More specifically, the processing circuitry 12 of the network node 10 may be configured to initiate (e.g. via the communications interface 16 of the network node 10) any of this rendering at the UE according to some embodiments. The rendering, at the UE, of the estimated carbon footprint for the UE with a carbon footprint for a reference activity provides the UE with feedback on the direct CO₂ impact. The reference activity can be an activity having well-recognised statistics (i.e. an activity that is well-recognised by a user of the UE), such as driving or flying. In this way, it is possible for a user of the UE to understand the extent of their energy consumption, compared to the energy consumption of an activity that they are familiar with. By reporting the results of the method described herein in comparison to a reference activity, it is possible to increase the understanding of telecommunications effects. Effectively, the total energy consumption for the reference activity puts the estimated total energy consumption for the UE into context. Thus, a personal-level consumption for the UE can be modelled according to some embodiments. This can serve as proof of user activity adaptations, e.g. when the network node 10 informs the UE (and thus the user of the UE who is the consumer) that a change in behaviour has a direct effect on the carbon footprint.

Although also not illustrated in FIG. 3, in some embodiments, the method may comprise controlling (e.g. guiding) one or more network orchestrators based on the estimated total energy consumption for the UE and/or the estimated carbon footprint for the UE, and/or controlling (e.g. guiding) network slice (or network function virtualisation, NFV) construction, composition and/or deployment based on the estimated total energy consumption for the UE and/or the estimated carbon footprint for the UE. More specifically, the processing circuitry 12 of the network node 10 may be configured to perform this control (e.g. via the communications interface 16 of the network node 10) according to some embodiments. In some embodiments, variable control strategies may be deployed to provide better control of energy consumption and/or carbon footprint.

In some embodiments, controlling one or more network orchestrators based on the estimated carbon footprint for the UE may comprise controlling the one or more network orchestrators to favour network nodes with the lowest total energy consumption per UE and/or the lowest carbon footprint (i.e. the lowest CO₂ impact) per UE when deciding on the deployment of network nodes. In some embodiments, controlling network slice (or NFV) construction, composition and/or deployment may include the ability to decide on a processing destination during orchestration, e.g. using an SCF and/or accounting for losses for various deployments. Examples of different deployments include, but are not limited to, cloud-RAN (C-RAN), distributed-RAN (D-RAN), virtual-RAN (V-RAN), open-RAN (O-RAN), and enterprise-RAN (E-RAN). In some embodiments, the estimated total energy consumption for the UE and/or the estimated carbon footprint for the UE can be provided as feedback to service level assurance (SLA). An SLA can comprise one or more processes and/or policies that verify that network services meet predefined service-level agreements (SLAs).

Although also not illustrated in FIG. 3, in some embodiments, the method may comprise generating a model to predict a future carbon footprint for the UE. More specifically, the processing circuitry 12 of the network node 10 may be configured to generate this model according to some embodiments. The model can be generated using the estimated carbon footprint for the UE and the estimated total energy consumption for the UE. In some embodiments, the model may be generated using a predicted emission factor for one or more energy sources powering the base station, such as any one or more of the energy sources mentioned earlier. In some embodiments, generating the model to predict the future carbon footprint for the UE may comprise compiling a look-up table to predict the future carbon footprint for the UE or training a machine learning model to predict the future carbon footprint for the UE. The prediction of the future carbon footprint for the UE from this model can be useful for reducing the carbon footprint in the network. Similarly, the combination of the model for predicting the future total energy consumption for the UE and the model for predicting the future carbon footprint for the UE can be useful for reducing both the energy consumption in the network and the carbon footprint in the network.

In the machine learning embodiments, the estimated carbon footprint for the UE provides the (ground truth) output for the machine learning model, and the estimated total energy consumption for the UE (and optionally also the predicted emission factor for one or more energy sources powering the base station) provides the corresponding input for the machine learning model for use in training the machine learning model to predict the future carbon footprint for the UE. The training data used to train the machine learning model can thus comprise the estimated carbon footprint for the UE and the estimated total energy consumption for the UE (and optionally also the predicted emission factor for one or more energy sources powering the base station). The machine learning model can learn a mapping between the inputs and the (ground truth) output. In this way, when an input is subsequently provided to the trained machine learning model, the trained machine learning model is able to predict a corresponding output. In some machine learning embodiments, the machine learning model that is trained to predict the future carbon footprint for the UE can be a long-short term memory (LSTM) model, or any other applicable machine learning model.

In some embodiments, the method can comprise using the model (e.g. the compiled look-up table and/or the trained machine learning model) to predict a future carbon footprint for the UE. More specifically, the processing circuitry 12 of the network node may be configured to use the model to make this prediction according to some embodiments. In the look-up table embodiments, using the model can comprise looking up an estimated total energy consumption for the UE (and optionally also an emission factor for one or more energy sources powering the base station that is serving the UE) in the look-up table to identify a corresponding carbon footprint. In the machine learning embodiments, using the model can comprise inputting into the trained machine learning model an estimated total energy consumption for the UE (and optionally also an emission factor for one or more energy sources powering the base station that is serving the UE). The output of the trained machine learning model is then the predicted future carbon footprint for the UE.

Although also not illustrated in FIG. 3, in some embodiments, the method may comprise determining an efficiency factor indicative of an efficiency of the base station when serving the UE. More specifically, the processing circuitry 12 of the network node 10 may be configured to determine the efficiency factor according to some embodiments. In some embodiments, the efficiency factor may be determined based on measurement data acquired on the base station during development (or production) of the base station (e.g. the equipment of the base station) and/or testing of the base station (e.g. the equipment of the base station) and/or operational data acquired on the base station during deployment of the base station in the network. Alternatively or in addition, in some embodiments, the efficiency factor may be determined using a statistical and/or machine learning process (or algorithm), such as those mentioned earlier, or related techniques.

For example, in some embodiments, the efficiency factor may be determined as a combination of measurements and/or adjustments from the operational data, e.g. using machine learning or related techniques. In some embodiments, the efficiency factor may be determined by measurements during equipment development and/or testing with possible adjustments based on the operational data during deployment, optionally using ML or related techniques. In some embodiments, clustering may be used to group base stations 20 according to a similarity of their operating environment (with those base stations 20 having a similar operating environment grouped together) and such a group of base stations 20 may be assigned the same efficiency factor.

Although also not illustrated in FIG. 3, in some embodiments, the method may comprise estimating changes in the total energy consumption for the UE based on periodic changes in the resource usage for the UE in the network and/or periodic changes in the measure of energy consumed by the base station in communicating with the UE. More specifically, the processing circuitry 12 of the network node 10 may be configured to estimate these changes according to some embodiments. The periodic changes in the resource usage for the UE may be reported to the network node 10 by the UE and/or the base station, and the periodic changes in the measure of energy consumed by the base station is reported to the network node 10 by the UE and/or the base station. In some embodiments, the method may comprise receiving information indicative of the periodic changes in the resource usage for the UE and the periodic changes in the measure of energy consumed by the base station. More specifically, the processing circuitry 12 of the network node 10 may be configured to receive this information (e.g. via the communications interface 16 of the network node 10) according to some embodiments. In some embodiments involving counters, the information may be received from one or more counters. In some embodiments, the information may be stored at the one or more counters.

Although also not illustrated in FIG. 3, in some embodiments, the method may comprise initiating rendering, at the UE, of the estimated changes in the total energy consumption for the UE. In some embodiments, the method may comprise initiating rendering, at the UE, of the estimated changes in the total energy consumption of the UE with corresponding changes in the total energy consumption for a reference activity that has an associated carbon footprint. More specifically, the processing circuitry 12 of the network node 10 may be configured to initiate (e.g. via the communications interface 16 of the network node 10) any of this rendering at the UE according to some embodiments.

Although also not illustrated in FIG. 3, in some embodiments, the method may comprise estimating changes in a carbon footprint for the UE based on the estimated changes in the total energy consumption for the UE. In some embodiments, the method may comprise estimating the changes in the carbon footprint for the UE based on the estimated changes in the total energy consumption for the UE and/or changes in an emission factor for the one or more energy sources powering the base station, such as any one or more of the energy sources mentioned earlier. More specifically, the processing circuitry 12 of the network node 10 may be configured to estimate these changes according to some embodiments.

Although also not illustrated in FIG. 3, in some embodiments, the method may comprise initiating rendering, at the UE, of the estimated changes in the carbon footprint for the UE. In some embodiments, the method may comprise initiating rendering, at the UE, of the estimated changes in the carbon footprint for the UE with corresponding changes in a carbon footprint for a reference activity. More specifically, the processing circuitry 12 of the network node 10 may be configured to initiate (e.g. via the communications interface 16 of the network node 10) any of this rendering at the UE according to some embodiments.

In some embodiments, the network node 10 (or, more specifically, the processing circuitry 12 of the network node 10) may use any one or more of the following equations to calculate any one or more of the parameters described herein:

$${C}_{UE} = ( {Cs}_{UE} + {Cd}_{UE} ) \cdot ( 1 - {RF}_{UE} ) , \qquad ( 1 )$$

$${Cs}_{UE} = \frac{{P}_{BS}}{{n}_{UE}} \cdot time \cdot SCF , \qquad ( 2 )$$

$${Cd}_{UE} = ( {\sum }_{i = 0}^{{n}_{carriers}} {\sum }_{j = 0}^{time} {CC}_{i} \cdot {PRB}_{ij} ) \cdot time \cdot SCF , \qquad ( 3 )$$

$${RF}_{UE} = \frac{{\sum }_{BS} {PRF}_{k} \cdot {n}_{radio , k}}{{n}_{UE}} , \qquad ( 4 )$$

$${P}_{BS} = EF \cdot {P}_{equipment} , \qquad ( 5 )$$

where C_{UE} denotes a total CO₂ emission of the UE (measured in grams of CO₂ emissions, gCO₂), Cs_{UE} denotes a static (i.e. regardless of traffic) CO₂ emission of the UE (measured in gCO₂), Cd_{UE} denotes a dynamic (i.e. corresponding to traffic) CO₂ emission of the UE (measured in gCO₂), P_{BS} denotes a static (i.e. regardless of traffic load) energy consumption of the base station serving the UE (measured in Watts, W), P_{equipment} denotes an energy consumption by the active equipment (e.g. radios, etc) of the base station serving the UE (measured in W), EF denotes an efficiency factor for the base station (which is unitless), SCF denotes a CO₂ emission factor (i.e. the carbon footprint) of the equipment of the base station serving the UE (measured in gCO₂/kWh), CCᵢ denotes a power efficiency factor of carrier i (which is unitless), PRBᵢⱼ denotes an energy for a resource (e.g. PRB) for a carrier i and time slot j (measured in W), PRFₖ denotes an energy reuse factor for base station k (which is unitless), RF_{UE} denotes an energy reuse factor per UE (which is unitless), n_{UE} denotes a number of UEs served by the base station (which is unitless), and n_{radio} denotes a number of radios in the base station serving the UE in a time period (which is unitless). The number of radios in the base station serving the UE in a time period is used since there may be multiple radios in the base station that each has its own reuse factor.

The efficiency factor EF for the base station can comprise at least one efficiency factor for the base station. In some embodiments, the efficiency factor EF for the base station may comprise a power supply efficiency factor PSF for the base station (which is unitless) and an equipment efficiency factor CF (e.g. a cooling factor, which is unitless). For example, in some embodiments, EF=PSF·CF. The efficiency factor EF (e.g. PSF and CF) reflects the (in)efficiency of the equipment of the base station in converting the received energy to work.

The total energy consumption for the UE 30 can be estimated from equations (1), (2) and (3) according to some embodiments. The UE's share of the energy consumption comprises the static energy consumption for the UE and the dynamic energy consumption for the UE 30, as described earlier. The carbon footprint (or, more specifically, the CO₂ consumption) for the UE 30 is proportional to the total energy consumption for the UE 30, as mentioned earlier.

The effect of the network architecture and deployment is captured implicitly in various efficiency factors used in equations. PSF, CF, CCᵢ can be affected by the network deployment options (e.g. whether the network is deployed as C-RAN, D-RAN, V-RAN, O-RAM or E-RAN). The energy reuse factors can be calculated from the returned energy versus the consumed energy (e.g. as measured by an energy counter). The efficiency factors (e.g. CCᵢ, CF) are unitless and can represent operational qualities of network equipment installed in the base station and other parts of the network with respect to energy use or reuse. The efficiency factors can be inherent properties of the equipment but may also depend on the operational environment.

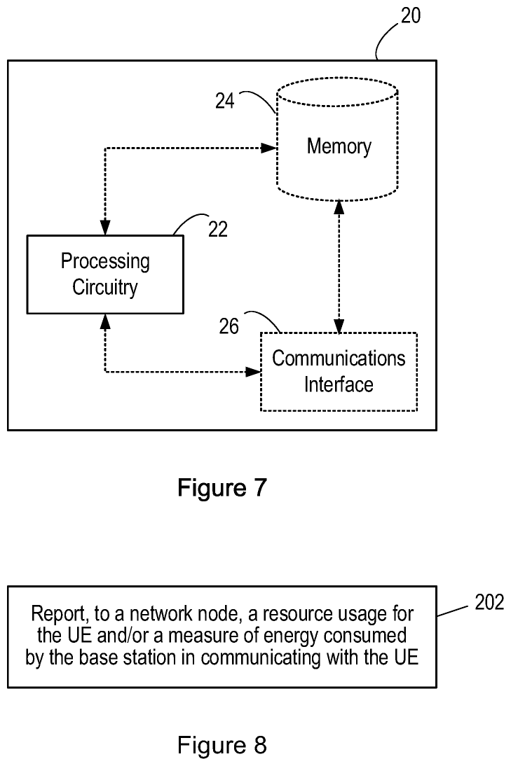

FIG. 7 illustrates a base station 20 in accordance with an embodiment. The base station 20 is for use in estimating a total energy consumption for a UE in a network. The network can comprise the base station 20.

The base station 20 referred to herein can refer to equipment capable, configured, arranged and/or operable to communicate directly or indirectly with the UE referred to herein, the network node 10 referred to herein, and/or with other network nodes or equipment to enable and/or to perform the functionality described herein, to provide access to the UE, and/or to perform other functions (e.g. administration) in the network. The base station 20 referred to herein may be a physical base station or a virtual base station as described in more detail later.

Examples of base stations include, but are not limited to, radio base stations, Node Bs, eNBs and NR NodeBs (gNBs). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A base station may also include one or more (or all) parts of a distributed radio base station such as centralized digital units and/or RRUs, sometimes referred to as RRHs. Such remote radio units may or may not be integrated with an antenna as an antenna integrated radio. Parts of a distributed radio base station may also be referred to as nodes in a DAS.

As illustrated in FIG. 7, the base station 20 comprises processing circuitry (or logic) 22. The processing circuitry 22 controls the operation of the base station 20 and can implement the method described herein in respect of the base station 20. The processing circuitry 22 can be configured or programmed to control the base station 20 in the manner described herein. The processing circuitry 22 can comprise one or more hardware components, such as one or more processors, one or more processing units, one or more multi-core processors and/or one or more modules. In particular implementations, each of the one or more hardware components can be configured to perform, or is for performing, individual or multiple steps of the method described herein in respect of the base station 20. In some embodiments, the processing circuitry 22 can be configured to run software to perform the method described herein in respect of the base station 20. The software may be containerised according to some embodiments. Thus, in some embodiments, the processing circuitry 22 may be configured to run a container to perform the method described herein in respect of the base station 20.

Briefly, the processing circuitry 22 of the base station 20 is configured to report, to the network node 10, a resource usage for the UE and/or a measure of energy consumed by the base station in communicating with the UE. The resource usage for the UE is for use, with the measure of energy consumed by the base station, in estimating a total energy consumption for the UE.

As illustrated in FIG. 7, in some embodiments, the base station 20 may optionally comprise a memory 24. The memory 24 of the base station 20 can comprise a volatile memory or a non-volatile memory. In some embodiments, the memory 24 of the base station 20 may comprise a non-transitory media. Examples of the memory 24 of the base station 20 include, but are not limited to, a random access memory (RAM), a read only memory (ROM), a mass storage media such as a hard disk, a removable storage media such as a compact disk (CD) or a digital video disk (DVD), and/or any other memory.

The processing circuitry 22 of the base station 20 can be connected to the memory 24 of the base station 20. In some embodiments, the memory 24 of the base station 20 may be for storing program code or instructions which, when executed by the processing circuitry 22 of the base station 20, cause the base station 20 to operate in the manner described herein in respect of the base station 20. For example, in some embodiments, the memory 24 of the base station 20 may be configured to store program code or instructions that can be executed by the processing circuitry 22 of the base station 20 to cause the base station 20 to operate in accordance with the method described herein in respect of the base station 20. Alternatively or in addition, the memory 24 of the base station 20 can be configured to store any information, data, messages, requests, responses, indications, notifications, signals, or similar, that are described herein. The processing circuitry 22 of the base station 20 may be configured to control the memory 24 of the base station 20 to store information, data, messages, requests, responses, indications, notifications, signals, or similar, that are described herein.

In some embodiments, as illustrated in FIG. 7, the base station 20 may optionally comprise a communications interface 26. The communications interface 26 of the base station 20 can be connected to the processing circuitry 22 of the base station 20 and/or the memory 24 of base station 20. The communications interface 26 of the base station may be operable to allow the processing circuitry 22 of the base station 20 to communicate with the memory 24 of the base station 20 and/or vice versa. Similarly, the communications interface 26 of the base station 20 may be operable to allow the processing circuitry 22 of the base station 20 to communicate with the network node 10 referred to herein, the UE referred to herein, any other entities referred to herein, and/or any nodes referred to herein. The communications interface 26 of the base station 20 can be configured to transmit and/or receive information, data, messages, requests, responses, indications, notifications, signals, or similar, that are described herein. In some embodiments, the processing circuitry 22 of the base station 20 may be configured to control the communications interface 26 of the base station 20 to transmit and/or receive information, data, messages, requests, responses, indications, notifications, signals, or similar, that are described herein.

Although the base station 20 is illustrated in FIG. 7 as comprising a single memory 24, it will be appreciated that the base station 20 may comprise at least one memory (i.e. a single memory or a plurality of memories) 24 that operate in the manner described herein. Similarly, although the base station 20 is illustrated in FIG. 7 as comprising a single communications interface 26, it will be appreciated that the base station 20 may comprise at least one communications interface (i.e. a single communications interface or a plurality of communications interface) 26 that operate in the manner described herein. It will also be appreciated that FIG. 7 only shows the components required to illustrate an embodiment of the base station 20 and, in practical implementations, the base station 20 may comprise additional or alternative components to those shown.

FIG. 8 is a flowchart illustrating a method performed by a base station 20 in accordance with an embodiment. The method is for use in estimating a total energy consumption of a UE in a network. The base station 20 described earlier with reference to FIG. 7 can be configured to operate in accordance with the method of FIG. 8. The method can be performed by or under the control of the processing circuitry 22 of the base station 20 according to some embodiments.

With reference to FIG. 8, as illustrated at block 202, a resource usage for the UE and/or a measure of energy consumed by the base station 20 in communicating with the UE is reported to a network node 10. More specifically, the processing circuitry 22 of the base station 20 can report the resource usage for the UE and/or the measure of energy consumed by the base station 20 according to some embodiments. In some embodiments, the measure of energy consumed by the base station 20 may be reported at the end of a call involving the UE, as part of a data transfer (e.g. transfer of a traffic usage report), and/or during handover of the UE from the base station 20 to another base station. In some embodiments, the measure of energy consumed by the base station 20 may be reported periodically. The resource usage for the UE is for use, with the measure of energy consumed by the base station 20, in estimating a total energy consumption for the UE. In some embodiments, the resource usage for the UE may be the number of resources in use by the UE.

In some embodiments, reporting may comprise initiating transmission of information indicative of the resource usage for the UE and/or the measure of energy consumed by the base station 20 towards the network node 10. More specifically, the processing circuitry 22 of the base station 20 may be configured to initiate transmission of this information (e.g. via the communications interface 26 of the base station 20) according to some embodiments. Herein, the term “initiate” can mean, for example, cause or establish. Thus, the processing circuitry 22 of the base station 20 can be configured to, e.g. via a communications interface 26 of the base station 20, itself transmit the information (e.g. via a communications interface 26 of the base station 20) or can be configured to cause another node to transmit the information.

In some embodiments, the base station 20 may comprise a counter configured to measure the energy consumed by the base station 20 in communicating with the UE. In these embodiments, the measure of energy consumed by the base station 20 can be acquired from the counter. More specifically, the processing circuitry 22 of the base station 20 can be configured to acquire (e.g. via a communications interface 26 of the base station 20) the measure of energy consumed by the base station 20 from the counter according to some embodiments. The counter may measure the energy consumed by the base station 20 using radio and/or baseband (BB). In embodiments involving a measure of energy reused by the base station 20, the base station 20 may comprise a counter configured to measure the energy reused by the base station 20. In these embodiments, the measure of energy reused by the base station 20 can be acquired from the counter. More specifically, the processing circuitry 22 of the base station 20 can be configured to acquire (e.g. via a communications interface 26 of the base station 20) the measure of energy reused by the base station 20 from the counter according to some embodiments. The counter for measuring the energy consumed by the base station 20 may be the same counter as, or a different counter to, the counter for measuring the energy reused by the base station 20. These counters can also be referred to as an energy counter. Alternatively or in addition, the base station 20 may comprise one or more counters configured to measure a carbon footprint (e.g. carbon emissions), an emissions factor, and/or a reuse factor. There may be one counter per hardware unit according to some embodiments. In some embodiments, there may be a counter for each UE, e.g. for each international mobile subscriber identity (IMSI). In some embodiments, the base station 20 may comprise a baseband scheduler configured to measure the energy consumed by the base station 20 in communicating with the UE.

Although not illustrated in FIG. 8, in some embodiments, the method may comprise reporting, to the network node, a measure of energy reused by the base station 20. In some embodiments, this may comprise initiating transmission of information indicative of the measure of energy reused by the base station 20 towards the network node 10. More specifically, the processing circuitry 22 of the base station 20 may be configured to initiate transmission of (e.g. itself transmit, such as via the communications interface 26 of the base station 20, or cause another node to transmit) this information according to some embodiments.

Although also not illustrated in FIG. 8, in some embodiments, the method may comprise reporting, to the network node 10, periodic changes in the resource usage for the UE in the network and/or periodic changes in the measure of energy consumed by the base station in communicating with the UE. In some embodiments, this may comprise initiating transmission of information indicative of the periodic changes in the resource usage for the UE and/or the periodic changes in the measure of energy consumed by the base station towards the network node 10. More specifically, the processing circuitry 22 of the base station 20 may be configured to initiate transmission of (e.g. itself transmit, such as via the communications interface 26 of the base station or cause another node to transmit) this information according to some embodiments. The periodic changes in the resource usage for the UE are for use, with the periodic changes in the measure of energy consumed by the base station 20, in estimating changes in the total energy consumption for the UE.

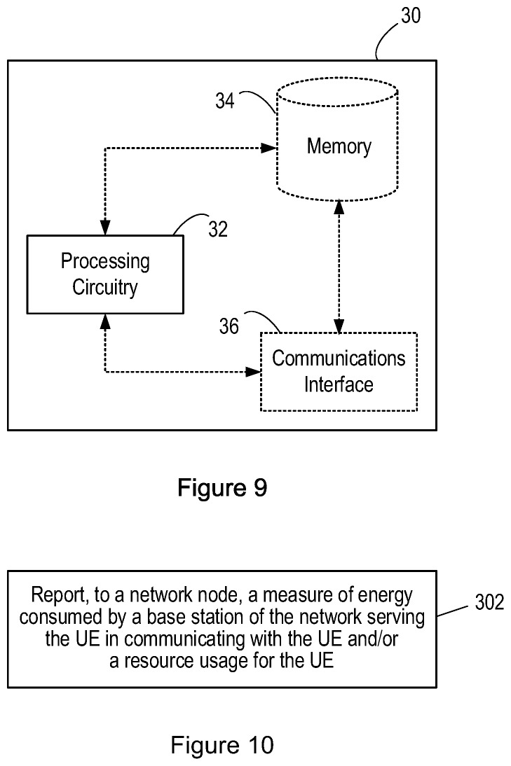

FIG. 9 illustrates a UE 30 in accordance with an embodiment. The UE 30 is for use in estimating a total energy consumption of a UE in a network. The network can comprise the UE 30. The UE 30 may also be referred to herein as a wireless device (WD). Thus, unless otherwise noted, the term WD may be used interchangeably herein with UE.

Herein, a UE refers to a device capable, configured, arranged and/or operable to communicate wirelessly with network nodes, base stations, and/or other wireless devices. Communicating wirelessly may involve transmitting and/or receiving wireless signals using electromagnetic waves, radio waves, infrared waves, and/or other types of signals suitable for conveying information through air. In some embodiments, a UE may be configured to transmit and/or receive information without direct human interaction. For instance, a UE may be designed to transmit information to a network on a predetermined schedule, when triggered by an internal or external event, or in response to requests from the network.

Examples of a UE include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc.

A UE may support device-to-device (D2D) communication, for example, by implementing a third generation partnership project (3GPP) standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a UE may represent a machine or other device that performs monitoring and/or measurements, and transmits the results of such monitoring and/or measurements to another UE and/or a network node. The UE may in this case be a machine-to-machine (M2M) device, which may in a 3GPP context be referred to as a machine type communication (MTC) device. As one particular example, the UE may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc) personal wearables (e.g. watches, fitness trackers, etc). In other scenarios, a UE may represent a vehicle or other equipment that is capable of monitoring and/or reporting on its operational status or other functions associated with its operation.

A UE as described above may represent the endpoint of a wireless connection, in which case the device may be referred to as a wireless terminal. Furthermore, a UE as described above may be mobile, in which case it may also be referred to as a mobile device or a mobile terminal.

As illustrated in FIG. 9, the UE 30 comprises processing circuitry (or logic) 32. The processing circuitry 32 controls the operation of the UE 30 and can implement the method described herein in respect of the UE 30. The processing circuitry 32 can be configured or programmed to control the UE 30 in the manner described herein. The processing circuitry 32 can comprise one or more hardware components, such as one or more processors, one or more processing units, one or more multi-core processors and/or one or more modules. In particular implementations, each of the one or more hardware components can be configured to perform, or is for performing, individual or multiple steps of the method described herein in respect of the UE 30. In some embodiments, the processing circuitry 32 can be configured to run software to perform the method described herein in respect of the UE 30. The software may be containerised according to some embodiments. Thus, in some embodiments, the processing circuitry 32 may be configured to run a container to perform the method described herein in respect of the UE 30.

Briefly, the processing circuitry 32 of the UE 30 is configured to report, to the network node 10, a measure of energy consumed by a base station 20 of the network serving the UE 30 in communicating with the UE 30 and/or a resource usage for the UE 30. The measure of energy consumed by the base station 20 is for use, with the resource usage for the UE 30, in estimating a total energy consumption for the UE 30.

As illustrated in FIG. 9, in some embodiments, the UE 30 may optionally comprise a memory 34. The memory 34 of the UE 30 can comprise a volatile memory or a non-volatile memory. In some embodiments, the memory 34 of the UE 30 may comprise a non-transitory media. Examples of the memory 34 of the UE 30 include, but are not limited to, a random access memory (RAM), a read only memory (ROM), a mass storage media such as a hard disk, a removable storage media such as a compact disk (CD) or a digital video disk (DVD), and/or any other memory.

The processing circuitry 32 of the UE 30 can be connected to the memory 34 of the UE In some embodiments, the memory 34 of the UE 30 may be for storing program code or instructions which, when executed by the processing circuitry 32 of the UE 30, cause the UE 30 to operate in the manner described herein in respect of the UE 30. For example, in some embodiments, the memory 34 of the UE 30 may be configured to store program code or instructions that can be executed by the processing circuitry 32 of the UE 30 to cause the UE 30 to operate in accordance with the method described herein in respect of the UE 30. Alternatively or in addition, the memory 34 of the UE 30 can be configured to store any information, data, messages, requests, responses, indications, notifications, signals, or similar, that are described herein. The processing circuitry 32 of the UE 30 may be configured to control the memory 34 of the UE 30 to store information, data, messages, requests, responses, indications, notifications, signals, or similar, that are described herein.

In some embodiments, as illustrated in FIG. 9, the UE 30 may optionally comprise a communications interface 36. The communications interface 36 of the UE 30 can be connected to the processing circuitry 32 of the UE 30 and/or the memory 34 of UE 30.

The communications interface 36 of the UE 30 may be operable to allow the processing circuitry 32 of the UE 30 to communicate with the memory 34 of the UE 30 and/or vice versa. Similarly, the communications interface 36 of the UE 30 may be operable to allow the processing circuitry 32 of the UE 30 to communicate with the network node 10 referred to herein, the base station 20 referred to herein, any other entities referred to herein, and/or any nodes referred to herein. The communications interface 36 of the UE can be configured to transmit and/or receive information, data, messages, requests, responses, indications, notifications, signals, or similar, that are described herein. In some embodiments, the processing circuitry 32 of the UE 30 may be configured to control the communications interface 36 of the UE 30 to transmit and/or receive information, data, messages, requests, responses, indications, notifications, signals, or similar, that are described herein.

Although the UE 30 is illustrated in FIG. 9 as comprising a single memory 34, it will be appreciated that the UE 30 may comprise at least one memory (i.e. a single memory or a plurality of memories) 34 that operate in the manner described herein. Similarly, although the UE 30 is illustrated in FIG. 9 as comprising a single communications interface 36, it will be appreciated that the UE 30 may comprise at least one communications interface (i.e. a single communications interface or a plurality of communications interface) 36 that operate in the manner described herein. It will also be appreciated that FIG. 9 only shows the components required to illustrate an embodiment of the UE 30 and, in practical implementations, the UE 30 may comprise additional or alternative components to those shown.

FIG. 10 is a flowchart illustrating a method performed by a UE 30 in accordance with an embodiment. The method is for use in estimating a total energy consumption of a UE in a network. The UE 30 described earlier with reference to FIG. 9 can be configured to operate in accordance with the method of FIG. 10. The method can be performed by or under the control of the processing circuitry 32 of the UE 30 according to some embodiments.

With reference to FIG. 10, as illustrated at block 302, a measure of energy consumed by a base station 20 of the network serving the UE 30 in communicating with the UE 30 and/or a resource usage for the UE 30 is reported to a network node 10. More specifically, the processing circuitry 32 of the UE 30 can report the resource usage for the UE and/or the measure of energy consumed by the UE 30 according to some embodiments. In some embodiments, the measure of energy consumed by the UE 30 may be reported at the end of a call involving the UE, as part of a data transfer (e.g. transfer of a traffic usage report), and/or during handover of the UE from the UE 30 to another base station. In some embodiments, the measure of energy consumed by the base station 20 may be reported periodically. The measure of energy consumed by the base station is for use, with the resource usage for the UE, in estimating a total energy consumption for the UE. In some embodiments, the resource usage for the UE may be the number of resources in use by the UE.

In some embodiments, reporting may comprise initiating transmission of information indicative of the resource usage for the UE and/or the measure of energy consumed by the UE 30 towards the network node 10. More specifically, the processing circuitry 32 of the UE 30 may be configured to initiate transmission of (e.g. itself transmit, such as via the communications interface 36 of the UE 30, or cause another node to transmit) this information according to some embodiments.

In some embodiments, the UE 30 may comprise a counter configured to measure the energy consumed by the base station 20. In these embodiments, the measure of energy consumed by the base station 20 can be acquired from the counter. More specifically, the processing circuitry 32 of the UE 30 can be configured to acquire (e.g. via a communications interface 36 of the UE 30) the measure of energy consumed by the base station 20 from the counter according to some embodiments. The counter can also be referred to as an energy counter. The counter may measure the energy consumed by the base station 20 using radio and/or baseband (BB). Alternatively or in addition, the UE 30 may comprise one or more counters configured to measure a carbon footprint (e.g. carbon emissions) and/or an emissions factor. There may be one counter per hardware unit according to some embodiments.

Although also not illustrated in FIG. 10, in some embodiments, the method may comprise reporting, to the network node 10, periodic changes in the resource usage for the UE 30 in the network and/or periodic changes in the measure of energy consumed by the base station 20 in communicating with the UE 30. In some embodiments, this may comprise initiating transmission of information indicative of the periodic changes in the resource usage for the UE 30 and/or the periodic changes in the measure of energy consumed by the base station 20 towards the network node 10. More specifically, the processing circuitry 32 of the UE 30 may be configured to initiate transmission of (e.g. itself transmit, such as via the communications interface 36 of the UE 30, or cause another node to transmit) this information according to some embodiments. The periodic changes in the measure of energy consumed by the base station 20 is for use, with the periodic changes in the resource usage for the UE 30, in estimating changes in the total energy consumption for the UE 30.

In some embodiments, the method described herein in respect of the network node 10 may be performed for a plurality of UEs in the network, the method described herein in respect of the base station 20 may be performed for a plurality of UEs in the network, and/or the method described herein in respect of the UE 30 may be performed by a plurality of UEs in the network. Thus, in addition to insight into the estimated (and/or predicted) total energy consumption and/or carbon footprint on a UE level, it is also possible to gain insight into the estimated (and/or predicted) total energy consumption and/or carbon footprint on a network level. For example, in some embodiments, the total energy consumption and/or the carbon footprint may be estimated (and/or predicted) in the manner described herein for a group of UEs or even for all UEs. In some embodiments, an accumulated estimation (and/or prediction) of the energy consumption and/or carbon footprint may be acquired on various levels, e.g. per UE and/or per enterprise customer. An enterprise customer may have a plurality (e.g. a large number of) UEs, such as in an IoT scenario or in the case of personal devices.

Moreover, in some embodiments, predictions can be made on an effect of changed UE behaviour. For example, periodic changes can be reported to show the UE 30 how its behaviour influences (for the better, worse, or indifferently) its energy consumption and/or carbon footprint. Similarly, in the case of multiple UEs (e.g. of an enterprise customer), periodic changes can be reported to show how the behaviour of those UEs influence (for the better, worse, or indifferently) their aggregate energy consumption and/or carbon footprint, such as by showing the effect of having fewer UEs operating at night versus day. In some embodiments, any of the predictions referred to herein may be provided (e.g. rendered) with a proposed change to the behaviour of the UE, or each UE in the case of the method being performed for multiple UEs (such as in the case of an enterprise customer), that reduces the energy consumption and/or the carbon footprint. The change may, for example, comprise switching to a different carrier and/or initiating a handover to another base station (e.g. with better energy performance). In some embodiments, a UE may be informed that a change in its behaviour will have a direct effect on energy consumption and/or carbon footprint.

There is also provided a method performed by a system for estimating a total energy consumption for a UE in a network. The method comprises the method described earlier in respect of the network node 10, the method described earlier in respect of the base station 20, and/or the method described earlier in respect of the UE 30. There is also provided a system for estimating a total energy consumption (and optionally also a carbon footprint) for a UE 30 in a network. The system comprises at least one network node 10 as described earlier, at least one base station 20 as described earlier, and/or at least one UE 30 as described earlier.

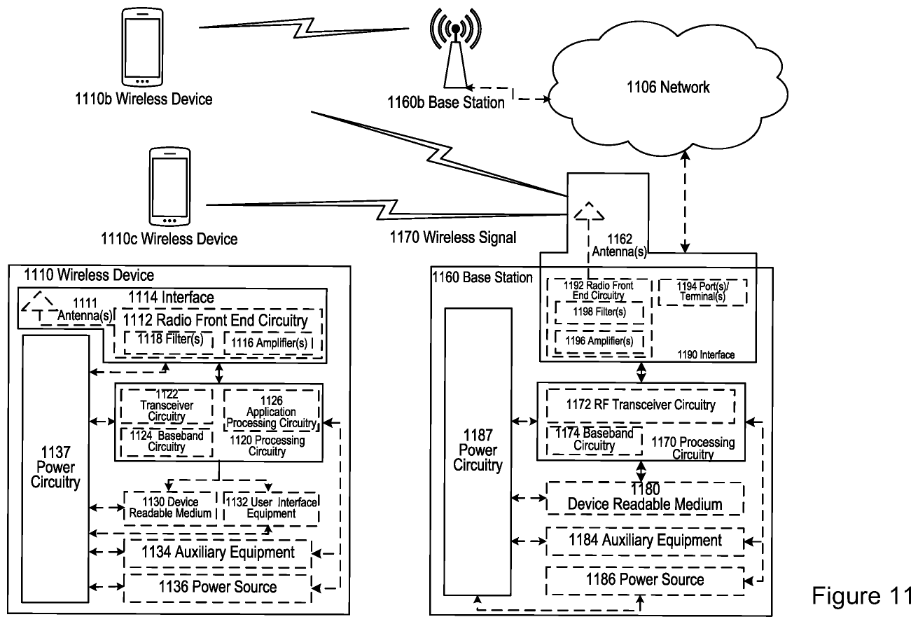

FIG. 11 illustrates a network in which the network node 10, the base station 20, and the UE 30 described herein can be implemented in accordance with an embodiment. In this embodiment, the network is a wireless network. For simplicity, the wireless network of FIG. 11 only depicts network 1106, base stations 1160 and 1160b, and WDs (or UEs) 1110, 1110b, and 1110c. The base stations 1160 and 1160b can be as described earlier with reference to FIGS. 7 and 8. The WDs can be as described earlier with reference to FIGS. 9 and 10. In practice, a wireless network may further include any additional elements suitable to support communication between wireless devices or between a wireless device and another communication device, such as the network node described earlier with reference to FIGS. 2 and 3, a landline telephone, a service provider, or any other network node or end device. Of the illustrated components, base station 1160 and wireless device (WD) 1110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

The base station 1160 and WD 1110 comprise various components described in more detail below. These components work together in order to provide base station and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

In FIG. 11, base station 1160 includes processing circuitry 1170, device readable medium 1180, interface 1190, auxiliary equipment 1184, power source 1186, power circuitry 1187, and antenna 1162. Although base station 1160 illustrated in the example wireless network of FIG. 11 may represent a device that includes the illustrated combination of hardware components, other embodiments may comprise base stations with different combinations of components (e.g. the components as described earlier with reference to FIG. 7). It is to be understood that a base station comprises any suitable combination of hardware and/or software needed to perform the tasks, features, functions and methods disclosed herein. Moreover, while the components of base station 1160 are depicted as single boxes located within a larger box, or nested within multiple boxes, in practice, a base station may comprise multiple different physical components that make up a single illustrated component (e.g. device readable medium 1180 may comprise multiple separate hard drives as well as multiple RAM modules).

Similarly, base station 1160 may be composed of multiple physically separate components (e.g. a NodeB component and a RNC component, or a BTS component and a BSC component, etc.), which may each have their own respective components. In certain scenarios in which base station 1160 comprises multiple separate components (e.g. BTS and BSC components), one or more of the separate components may be shared among several base stations. For example, a single RNC may control multiple.

NodeB's. In such a scenario, each unique NodeB and RNC pair, may in some instances be considered a single separate base station. In some embodiments, base station 1160 may be configured to support multiple radio access technologies (RATs). In such embodiments, some components may be duplicated (e.g. separate device readable medium 1180 for the different RATs) and some components may be reused (e.g. the same antenna 1162 may be shared by the RATs). Base station 1160 may also include multiple sets of the various illustrated components for different wireless technologies integrated into network node 1160, such as, for example, GSM, Wide Code Division Multiplexing Access (WCDMA), LTE, NR, WiFi, or Bluetooth wireless technologies. These wireless technologies may be integrated into the same or different chip or set of chips and other components within base station 1160.

Processing circuitry 1170 is configured to perform any determining, calculating, or similar operations (e.g. certain obtaining operations) described herein as being provided by a base station. These operations performed by processing circuitry 1170 may include processing information obtained by processing circuitry 1170 by, for example, converting the obtained information into other information, comparing the obtained information or converted information to information stored in the base station, and/or performing one or more operations based on the obtained information or converted information, and as a result of said processing making a determination.

Processing circuitry 1170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other base station 1160 components, such as device readable medium 1180, base station 1160 functionality. For example, processing circuitry 1170 may execute instructions stored in device readable medium 1180 or in memory within processing circuitry 1170. Such functionality may include providing any of the various wireless features, functions, or benefits discussed herein. In some embodiments, processing circuitry 1170 may include a system on a chip (SOC).

In some embodiments, processing circuitry 1170 may include one or more of radio frequency (RF) transceiver circuitry 1172 and baseband processing circuitry 1174. In some embodiments, radio frequency (RF) transceiver circuitry 1172 and baseband processing circuitry 1174 may be on separate chips (or sets of chips), boards, or units, such as radio units and digital units. In alternative embodiments, part or all of RF transceiver circuitry 1172 and baseband processing circuitry 1174 may be on the same chip or set of chips, boards, or units.

In certain embodiments, some or all of the functionality described herein as being provided by a base station may be performed by processing circuitry 1170 executing instructions stored on device readable medium 1180 or memory within processing circuitry 1170. In alternative embodiments, some or all of the functionality may be provided by processing circuitry 1170 without executing instructions stored on a separate or discrete device readable medium, such as in a hard-wired manner. In any of those embodiments, whether executing instructions stored on a device readable storage medium or not, processing circuitry 1170 can be configured to perform the described functionality. The benefits provided by such functionality are not limited to processing circuitry 1170 alone or to other components of base station 1160, but are enjoyed by base station 1160 as a whole, and/or by end users and the wireless network generally.

Device readable medium 1180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1170. Device readable medium 1180 may store any suitable instructions, data or information, including a computer program, software, an application including one or more of logic, rules, code, tables, etc. and/or other instructions capable of being executed by processing circuitry 1170 and, utilized by base station 1160. Device readable medium 1180 may be used to store any calculations made by processing circuitry 1170 and/or any data received via interface 1190. In some embodiments, processing circuitry 1170 and device readable medium 1180 may be considered to be integrated.

Interface 1190 is used in the wired or wireless communication of signalling and/or data between base station 1160, network 1106, and/or WDs 1110. As illustrated, interface 1190 comprises port(s)/terminal(s) 1194 to send and receive data, for example to and from network 1106 over a wired connection. Interface 1190 also includes radio front end circuitry 1192 that may be coupled to, or in certain embodiments a part of, antenna 1162. Radio front end circuitry 1192 comprises filters 1198 and amplifiers 1196. Radio front end circuitry 1192 may be connected to antenna 1162 and processing circuitry 1170. Radio front end circuitry may be configured to condition signals communicated between antenna 1162 and processing circuitry 1170. Radio front end circuitry 1192 may receive digital data that is to be sent out to other network nodes or WDs via a wireless connection. Radio front end circuitry 1192 may convert the digital data into a radio signal having the appropriate channel and bandwidth parameters using a combination of filters 1198 and/or amplifiers 1196. The radio signal may then be transmitted via antenna 1162. Similarly, when receiving data, antenna 1162 may collect radio signals which are then converted into digital data by radio front end circuitry 1192. The digital data may be passed to processing circuitry 1170. In other embodiments, the interface may comprise different components and/or different combinations of components.

In certain alternative embodiments, base station 1160 may not include separate radio front end circuitry 1192, instead, processing circuitry 1170 may comprise radio front end circuitry and may be connected to antenna 1162 without separate radio front end circuitry 1192. Similarly, in some embodiments, all or some of RF transceiver circuitry 1172 may be considered a part of interface 1190. In still other embodiments, interface 1190 may include one or more ports or terminals 1194, radio front end circuitry 1192, and RF transceiver circuitry 1172, as part of a radio unit (not shown), and interface 1190 may communicate with baseband processing circuitry 1174, which is part of a digital unit (not shown).

Antenna 1162 may include one or more antennas, or antenna arrays, configured to send and/or receive wireless signals. Antenna 1162 may be coupled to radio front end circuitry 1190 and may be any type of antenna capable of transmitting and receiving data and/or signals wirelessly. In some embodiments, antenna 1162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as M IMO (multiple input multiple output). In certain embodiments, antenna 1162 may be separate from base station 1160 and may be connectable to base station 1160 through an interface or port.

Antenna 1162, interface 1190, and/or processing circuitry 1170 may be configured to perform any receiving operations and/or certain obtaining operations described herein as being performed by a base station. Any information, data and/or signals may be received from a wireless device, another network node and/or any other network equipment. Similarly, antenna 1162, interface 1190, and/or processing circuitry 1170 may be configured to perform any transmitting operations described herein as being performed by a base station. Any information, data and/or signals may be transmitted to a wireless device, another network node and/or any other network equipment.

Power circuitry 1187 may comprise, or be coupled to, power management circuitry and is configured to supply the components of base station 1160 with power for performing the functionality described herein. Power circuitry 1187 may receive power from power source 1186. Power source 1186 and/or power circuitry 1187 may be configured to provide power to the various components of base station 1160 in a form suitable for the respective components (e.g. at a voltage and current level needed for each respective component). Power source 1186 may either be included in, or external to, power circuitry 1187 and/or base station 1160. For example, base station 1160 may be connectable to an external power source (e.g. an electricity outlet) via an input circuitry or interface such as an electrical cable, whereby the external power source supplies power to power circuitry 1187. As a further example, power source 1186 may comprise a source of power in the form of a battery or battery pack which is connected to, or integrated in, power circuitry 1187. The battery may provide backup power should the external power source fail. Other types of power sources, such as photovoltaic devices, may also be used.

Alternative embodiments of base station 1160 may include additional components beyond those shown in FIG. 11 that may be responsible for providing certain aspects of the base station's functionality, including any of the functionality described herein and/or any functionality necessary to support the subject-matter described herein. For example, base station 1160 may include user interface equipment to allow input of information into base station 1160 and to allow output of information from base station 1160. This may allow a user to perform diagnostic, maintenance, repair, and other administrative functions for base station 1160.

Although not illustrated in FIG. 11, the network node 10 referred to herein may include any one or more of the same components as the base station 1160 illustrated in and described with reference to FIG. 11. Thus, the description of the components of the base station 1160 of FIG. 11 will be understood to equally apply to the network node referred to herein.

As illustrated, WD 1110 includes antenna 1111, interface 1114, processing circuitry 1120, device readable medium 1130, user interface equipment 1132, auxiliary equipment 1134, power source 1136 and power circuitry 1137. WD 1110 may include multiple sets of one or more of the illustrated components for different wireless technologies supported by WD 1110, such as, for example, GSM, WCDMA, LTE, NR, WiFi, WiMAX, or Bluetooth wireless technologies, just to mention a few. These wireless technologies may be integrated into the same or different chips or set of chips as other components within WD 1110.

Antenna 1111 may include one or more antennas or antenna arrays, configured to send and/or receive wireless signals, and is connected to interface 1114. In certain alternative embodiments, antenna 1111 may be separate from WD 1110 and be connectable to WD 1110 through an interface or port. Antenna 1111, interface 1114, and/or processing circuitry 1120 may be configured to perform any receiving or transmitting operations described herein as being performed by a WD. Any information, data and/or signals may be received from a network node and/or another WD. In some embodiments, radio front end circuitry and/or antenna 1111 may be considered an interface.

As illustrated, interface 1114 comprises radio front end circuitry 1112 and antenna 1111. Radio front end circuitry 1112 comprise one or more filters 1118 and amplifiers 1116. Radio front end circuitry 1112 is connected to antenna 1111 and processing circuitry 1120, and is configured to condition signals communicated between antenna 1111 and processing circuitry 1120. Radio front end circuitry 1112 may be coupled to or a part of antenna 1111. In some embodiments, WD 1110 may not include separate radio front end circuitry 1112; rather, processing circuitry 1120 may comprise radio front end circuitry and may be connected to antenna 1111. Similarly, in some embodiments, some or all of RF transceiver circuitry 1122 may be considered a part of interface 1114. Radio front end circuitry 1112 may receive digital data that is to be sent out to other network nodes or WDs via a wireless connection. Radio front end circuitry 1112 may convert the digital data into a radio signal having the appropriate channel and bandwidth parameters using a combination of filters 1118 and/or amplifiers 1116. The radio signal may then be transmitted via antenna 1111. Similarly, when receiving data, antenna 1111 may collect radio signals which are then converted into digital data by radio front end circuitry 1112. The digital data may be passed to processing circuitry 1120. In other embodiments, the interface may comprise different components and/or different combinations of components.

Processing circuitry 1120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1110 components, such as device readable medium 1130, WD 1110 functionality. Such functionality may include providing any of the various wireless features or benefits discussed herein. For example, processing circuitry 1120 may execute instructions stored in device readable medium 1130 or in memory within processing circuitry 1120 to provide the functionality disclosed herein.

As illustrated, processing circuitry 1120 includes one or more of RF transceiver circuitry 1122, baseband processing circuitry 1124, and application processing circuitry 1126. In other embodiments, the processing circuitry may comprise different components and/or different combinations of components. In certain embodiments processing circuitry 1120 of WD 1110 may comprise a SOC. In some embodiments, RF transceiver circuitry 1122, baseband processing circuitry 1124, and application processing circuitry 1126 may be on separate chips or sets of chips. In alternative embodiments, part or all of baseband processing circuitry 1124 and application processing circuitry 1126 may be combined into one chip or set of chips, and RF transceiver circuitry 1122 may be on a separate chip or set of chips. In still alternative embodiments, part or all of RF transceiver circuitry 1122 and baseband processing circuitry 1124 may be on the same chip or set of chips, and application processing circuitry 1126 may be on a separate chip or set of chips. In yet other alternative embodiments, part or all of RF transceiver circuitry 1122, baseband processing circuitry 1124, and application processing circuitry 1126 may be combined in the same chip or set of chips. In some embodiments, RF transceiver circuitry 1122 may be a part of interface 1114. RF transceiver circuitry 1122 may condition RF signals for processing circuitry 1120.

In certain embodiments, some or all of the functionality described herein as being performed by a WD may be provided by processing circuitry 1120 executing instructions stored on device readable medium 1130, which in certain embodiments may be a computer-readable storage medium. In alternative embodiments, some or all of the functionality may be provided by processing circuitry 1120 without executing instructions stored on a separate or discrete device readable storage medium, such as in a hard-wired manner. In any of those particular embodiments, whether executing instructions stored on a device readable storage medium or not, processing circuitry 1120 can be configured to perform the described functionality. The benefits provided by such functionality are not limited to processing circuitry 1120 alone or to other components of WD 1110, but are enjoyed by WD 1110 as a whole, and/or by end users and the wireless network generally.

Processing circuitry 1120 may be configured to perform any determining, calculating, or similar operations (e.g. certain obtaining operations) described herein as being performed by a WD. These operations, as performed by processing circuitry 1120, may include processing information obtained by processing circuitry 1120 by, for example, converting the obtained information into other information, comparing the obtained information or converted information to information stored by WD 1110, and/or performing one or more operations based on the obtained information or converted information, and as a result of said processing making a determination.

Device readable medium 1130 may be operable to store a computer program, software, an application including one or more of logic, rules, code, tables, etc. and/or other instructions capable of being executed by processing circuitry 1120. Device readable medium 1130 may include computer memory (e.g. Random Access Memory (RAM) or Read Only Memory (ROM)), mass storage media (e.g. a hard disk), removable storage media (e.g. a Compact Disk (CD) or a Digital Video Disk (DVD)), and/or any other volatile or non-volatile, non-transitory device readable and/or computer executable memory devices that store information, data, and/or instructions that may be used by processing circuitry 1120. In some embodiments, processing circuitry 1120 and device readable medium 1130 may be considered to be integrated.

User interface equipment 1132 may provide components that allow for a human user to interact with WD 1110. Such interaction may be of many forms, such as visual, audial, tactile, etc. User interface equipment 1132 may be operable to produce output to the user and to allow the user to provide input to WD 1110. The type of interaction may vary depending on the type of user interface equipment 1132 installed in WD 1110. For example, if WD 1110 is a smart phone, the interaction may be via a touch screen; if WD 1110 is a smart meter, the interaction may be through a screen that provides usage (e.g. the number of gallons used) or a speaker that provides an audible alert (e.g. if smoke is detected). User interface equipment 1132 may include input interfaces, devices and circuits, and output interfaces, devices and circuits. User interface equipment 1132 is configured to allow input of information into WD 1110, and is connected to processing circuitry 1120 to allow processing circuitry 1120 to process the input information. User interface equipment 1132 may include, for example, a microphone, a proximity or other sensor, keys/buttons, a touch display, one or more cameras, a USB port, or other input circuitry. User interface equipment 1132 is also configured to allow output of information from WD 1110, and to allow processing circuitry 1120 to output information from WD 1110. User interface equipment 1132 may include, for example, a speaker, a display, vibrating circuitry, a Universal Serial Bus (USB) port, a headphone interface, or other output circuitry. Using one or more input and output interfaces, devices, and circuits, of user interface equipment 1132, WD 1110 may communicate with end users and/or the wireless network, and allow them to benefit from the functionality described herein.

Auxiliary equipment 1134 is operable to provide more specific functionality which may not be generally performed by WDs. This may comprise specialized sensors for doing measurements for various purposes, interfaces for additional types of communication such as wired communications etc. The inclusion and type of components of auxiliary equipment 1134 may vary depending on the embodiment and/or scenario.

Power source 1136 may, in some embodiments, be in the form of a battery or battery pack. Other types of power sources, such as an external power source (e.g. an electricity outlet), photovoltaic devices or power cells, may also be used. WD 1110 may further comprise power circuitry 1137 for delivering power from power source 1136 to the various parts of WD 1110 which need power from power source 1136 to carry out any functionality described or indicated herein. Power circuitry 1137 may in certain embodiments comprise power management circuitry. Power circuitry 1137 may additionally or alternatively be operable to receive power from an external power source; in which case WD 1110 may be connectable to the external power source (such as an electricity outlet) via input circuitry or an interface such as an electrical power cable. Power circuitry 1137 may also in certain embodiments be operable to deliver power from an external power source to power source 1136. This may be, for example, for the charging of power source 1136. Power circuitry 1137 may perform any formatting, converting, or other modification to the power from power source 1136 to make the power suitable for the respective components of WD 1110 to which power is supplied.

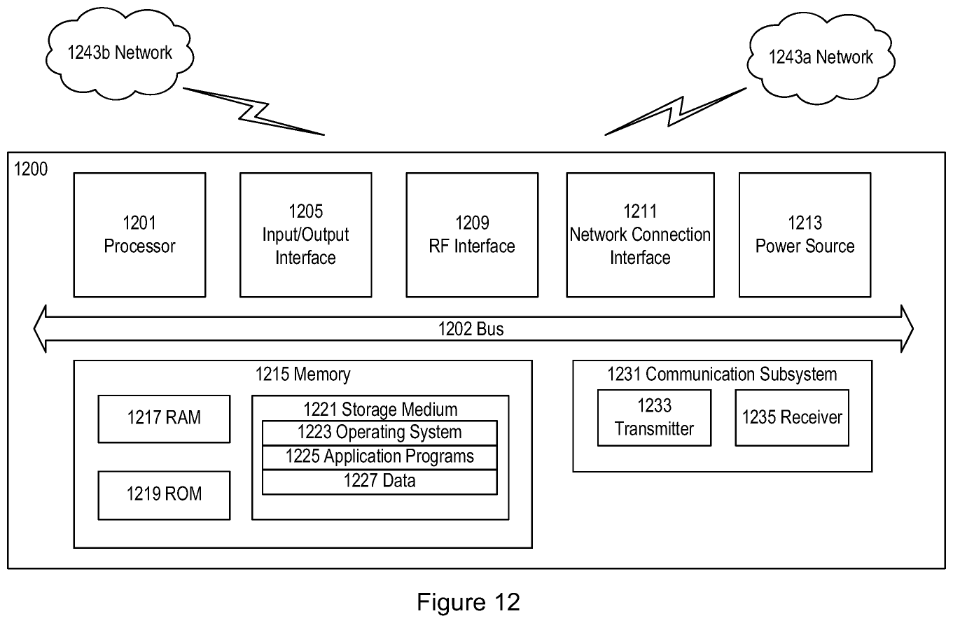

FIG. 12 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g. a smart sprinkler controller). Alternatively, a UE may represent a device that is not intended for sale to, or operation by, an end user but which may be associated with or operated for the benefit of a user (e.g. a smart power meter). UE 1200 may be any UE identified by the 3GPP, including a NB-IoT UE, a MTC UE, and/or an enhanced MTC (eMTC) UE. UE 1200, as illustrated in FIG. 12, is one example of a WD configured for communication in accordance with one or more communication standards promulgated by the 3GPP, such as 3GPP's GSM, UMTS, LTE, and/or 5G standards. As mentioned previously, the term WD and UE may be used interchangeable. Accordingly, although FIG. 12 is a UE, the components discussed herein are equally applicable to a WD, and vice-versa.

In FIG. 12, UE 1200 includes processing circuitry 1201 that is operatively coupled to input/output interface 1205, radio frequency (RF) interface 1209, network connection interface 1211, memory 1215 including random access memory (RAM) 1217, read-only memory (ROM) 1219, and storage medium 1221 or the like, communication subsystem 1231, power source 1213, and/or any other component, or any combination thereof. Storage medium 1221 includes operating system 1223, application program 1225, and data 1227. In other embodiments, storage medium 1221 may include other similar types of information. Certain UEs may utilize all of the components shown in FIG. 12, or only a subset of the components. The level of integration between the components may vary from one UE to another UE. Further, certain UEs may contain multiple instances of a component, such as multiple processors, memories, transceivers, transmitters, receivers, etc.

In FIG. 12, processing circuitry 1201 may be configured to process computer instructions and data. Processing circuitry 1201 may be configured to implement any sequential state machine operative to execute machine instructions stored as machine-readable computer programs in the memory, such as one or more hardware-implemented state machines (e.g. in discrete logic, Field-Programmable Gate Array (FPGA), Application-Specific Integrated Circuit (ASIC), etc); programmable logic together with appropriate firmware; one or more stored program, general-purpose processors, such as a microprocessor or Digital Signal Processor (DSP), together with appropriate software; or any combination of the above. For example, the processing circuitry 1201 may include two central processing units (CPUs). Data may be information in a form suitable for use by a computer.

In the depicted embodiment, input/output interface 1205 may be configured to provide a communication interface to an input device, output device, or input and output device. UE 1200 may be configured to use an output device via input/output interface 1205. An output device may use the same type of interface port as an input device. For example, a USB port may be used to provide input to and output from UE 1200. The output device may be a speaker, a sound card, a video card, a display, a monitor, a printer, an actuator, an emitter, a smartcard, another output device, or any combination thereof. UE 1200 may be configured to use an input device via input/output interface 1205 to allow a user to capture information into UE 1200. The input device may include a touch-sensitive or presence-sensitive display, a camera (e.g. a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 12, RF interface 1209 may be configured to provide a communication interface to RF components such as a transmitter, a receiver, and an antenna. Network connection interface 1211 may be configured to provide a communication interface to network 1243a. Network 1243a may encompass wired and/or wireless networks such as a local-area network (LAN), a wide-area network (WAN), a computer network, a wireless network, a telecommunications network, another like network or any combination thereof. For example, network 1243a may comprise a Wi-Fi network. Network connection interface 1211 may be configured to include a receiver and a transmitter interface used to communicate with one or more other devices over a communication network according to one or more communication protocols, such as Ethernet, Transmission Control Protocol/Internet Protocol (TCP/IP), Synchronous Optical Networking (SONET), Asynchronous Transfer Mode (ATM), or the like. Network connection interface 1211 may implement receiver and transmitter functionality appropriate to the communication network links (e.g. optical, electrical, and the like). The transmitter and receiver functions may share circuit components, software or firmware, or alternatively may be implemented separately.

RAM 1217 may be configured to interface via bus 1202 to processing circuitry 1201 to provide storage or caching of data or computer instructions during the execution of software programs such as the operating system, application programs, and device drivers. ROM 1219 may be configured to provide computer instructions or data to processing circuitry 1201. For example, ROM 1219 may be configured to store invariant low-level system code or data for basic system functions such as basic input and output (I/O), startup, or reception of keystrokes from a keyboard that are stored in a non-volatile memory. Storage medium 1221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1221 may be configured to include operating system 1223, application program 1225 such as a web browser application, a widget or gadget engine or another application, and data 1227. Storage medium 1221 may store, for use by UE 1200, any of a variety of various operating systems or combinations of operating systems.

Storage medium 1221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1221 may allow UE 1200 to access computer-executable instructions, application programs or the like, stored on transitory or non-transitory memory media, to off-load data, or to upload data. An article of manufacture, such as one utilizing a communication system may be tangibly embodied in storage medium 1221, which may comprise a device readable medium.

In FIG. 12, processing circuitry 1201 may be configured to communicate with network 1243b using communication subsystem 1231. Network 1243a and network 1243b may be the same network or networks or different network or networks. Communication subsystem 1231 may be configured to include one or more transceivers used to communicate with network 1243b. For example, communication subsystem 1231 may be configured to include one or more transceivers used to communicate with one or more remote transceivers of another device capable of wireless communication such as another WD or base station of a radio access network (RAN) according to one or more communication protocols, such as IEEE 802.11, CDMA, WCDMA, GSM, LTE, UTRAN, WiMax, or the like. Each transceiver may include transmitter 1233 and/or receiver 1235 to implement transmitter or receiver functionality, respectively, appropriate to the RAN links (e.g. frequency allocations and the like). Further, transmitter 1233 and receiver 1235 of each transceiver may share circuit components, software or firmware, or alternatively may be implemented separately.

In the illustrated embodiment, the communication functions of communication subsystem 1231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1231 may include cellular communication, Wi-Fi communication, Bluetooth communication, and GPS communication. Network 1243b may encompass wired and/or wireless networks such as a local-area network (LAN), a wide-area network (WAN), a computer network, a wireless network, a telecommunications network, another like network or any combination thereof. For example, network 1243b may be a cellular network, a Wi-Fi network, and/or a near-field network. Power source 1213 may be configured to provide alternating current (AC) or direct current (DC) power to components of UE 1200.

The features, benefits and/or functions described herein may be implemented in one of the components of UE 1200 or partitioned across multiple components of UE 1200. Further, the features, benefits, and/or functions described herein may be implemented in any combination of hardware, software or firmware. In one example, communication subsystem 1231 may be configured to include any of the components described herein. Further, processing circuitry 1201 may be configured to communicate with any of such components over bus 1202. In another example, any of such components may be represented by program instructions stored in memory that when executed by processing circuitry 1201 perform the corresponding functions described herein. In another example, the functionality of any of such components may be partitioned between processing circuitry 1201 and communication subsystem 1231. In another example, the non-computationally intensive functions of any of such components may be implemented in software or firmware and the computationally intensive functions may be implemented in hardware.

In some embodiments, the network node, base station and/or UE functionality described herein can be performed by hardware. Thus, in some embodiments, the network node, base station and/or UE described herein can be a hardware entity. However, it will also be understood that optionally at least part or all of the network node, base station and/or UE functionality described herein can be virtualized. For example, the functions performed by the network node, base station and/or UE described herein can be implemented in software running on generic hardware that is configured to orchestrate the functionality. Thus, in some embodiments, the network node, base station and/or UE described herein can be a virtual entity. In some embodiments, at least part or all of the network node, base station and/or UE functionality described herein may be performed in a network enabled cloud. Thus, the method described herein can be realised as a cloud implementation according to some embodiments. The network node, base station and/or UE functionality described herein may all be at the same location or at least some of the functionality may be distributed, e.g. the functionality of any one or more of the network node, base station and UE described herein may be performed by one or more different entities.

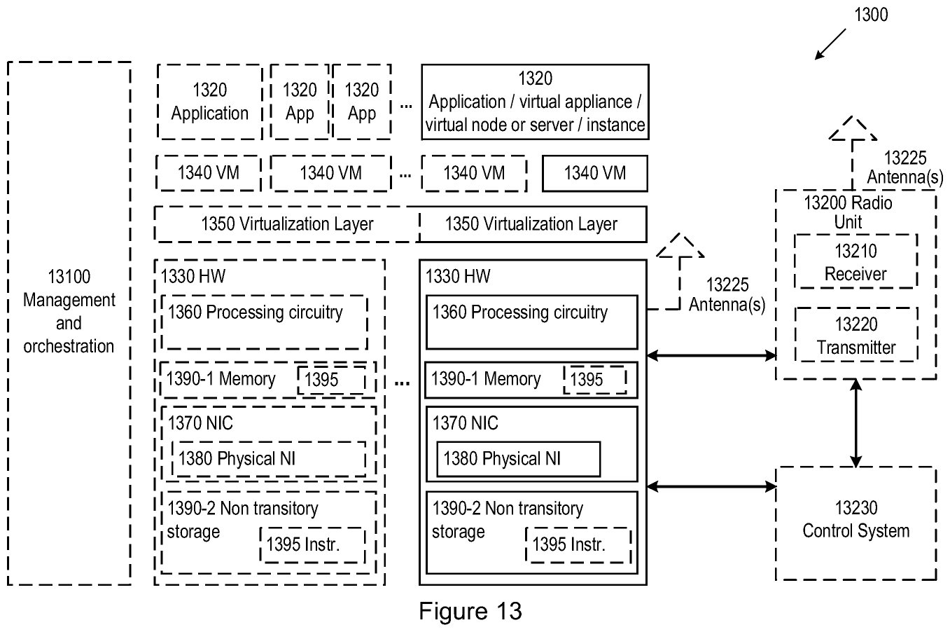

FIG. 13 is a schematic block diagram illustrating a virtualization environment 1300 in which functions implemented by some embodiments may be virtualized. In the present context, virtualizing means creating virtual versions of apparatuses or devices which may include virtualizing hardware platforms, storage devices and networking resources.

As used herein, virtualization can be applied to the network node referred to herein, the base station referred to herein, or to the UE referred to herein, or components thereof, and relates to an implementation in which at least a portion of the functionality is implemented as one or more virtual components (e.g. via one or more applications, components, functions, virtual machines or containers executing on one or more physical processing nodes in one or more networks). In some embodiments, some or all of the functions described herein may be implemented as virtual components executed by one or more virtual machines implemented in one or more virtual environments 1300 hosted by one or more of hardware nodes 1330. Further, in embodiments in which the virtual node is not a radio access node or does not require radio connectivity (e.g. a core network node), then the network node may be entirely virtualized.

The functions may be implemented by one or more applications 1320 (which may alternatively be called software instances, virtual appliances, network functions, virtual nodes, virtual network functions, etc.) operative to implement some of the features, functions, and/or benefits of some of the embodiments disclosed herein. Applications 1320 are run in virtualization environment 1300 which provides hardware 1330 comprising processing circuitry 1360 and memory 1390. Memory 1390 contains instructions 1395 executable by processing circuitry 1360 whereby application 1320 is operative to provide one or more of the features, benefits, and/or functions disclosed herein.

Virtualization environment 1300, comprises general-purpose or special-purpose network hardware devices 1330 comprising a set of one or more processors or processing circuitry 1360, which may be commercial off-the-shelf (COTS) processors, dedicated Application Specific Integrated Circuits (ASICs), or any other type of processing circuitry including digital or analog hardware components or special purpose processors. Each hardware device may comprise memory 1390-1 which may be non-persistent memory for temporarily storing instructions 1395 or software executed by processing circuitry 1360. Each hardware device may comprise one or more network interface controllers (NICs) 1370, also known as network interface cards, which include physical network interface 1380. Each hardware device may also include non-transitory, persistent, machine-readable storage media 1390-2 having stored therein software 1395 and/or instructions executable by processing circuitry 1360. Software 1395 may include any type of software including software for instantiating one or more virtualization layers 1350 (also referred to as hypervisors), software to execute virtual machines 1340 as well as software allowing it to execute functions, features and/or benefits described in relation with some embodiments described herein.

Virtual machines 1340, comprise virtual processing, virtual memory, virtual networking or interface and virtual storage, and may be run by a corresponding virtualization layer 1350 or hypervisor. Different embodiments of the instance of virtual application 1320 may be implemented on one or more of virtual machines 1340, and the implementations may be made in different ways.

During operation, processing circuitry 1360 executes software 1395 to instantiate the hypervisor or virtualization layer 1350, which may sometimes be referred to as a virtual machine monitor (VMM). Virtualization layer 1350 may present a virtual operating platform that appears like networking hardware to virtual machine 1340.

As shown in FIG. 13, hardware 1330 may be a standalone network node with generic or specific components. Hardware 1330 may comprise antenna 13225 and may implement some functions via virtualization. Alternatively, hardware 1330 may be part of a larger cluster of hardware (e.g. such as in a data center or customer premise equipment (CPE)) where many hardware nodes work together and are managed via management and orchestration (MANO) 13100, which, among others, oversees lifecycle management of applications 1320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1340 may be a software implementation of a physical machine that runs programs as if they were executing on a physical, non-virtualized machine. Each of virtual machines 1340, and that part of hardware 1330 that executes that virtual machine, be it hardware dedicated to that virtual machine and/or hardware shared by that virtual machine with others of the virtual machines 1340, forms a separate virtual network elements (VNE). Still in the context of NFV, Virtual Network Function (VNF) is responsible for handling specific network functions that run in one or more virtual machines 1340 on top of hardware networking infrastructure 1330 and corresponds to application 1320 in FIG. 13.

In some embodiments, one or more radio units 13200 that each include one or more transmitters 13220 and one or more receivers 13210 may be coupled to one or more antennas 13225. Radio units 13200 may communicate directly with hardware nodes 1330 via one or more appropriate network interfaces and may be used in combination with the virtual components to provide a virtual node with radio capabilities, such as a radio access node or a base station. In some embodiments, some signalling can be effected with the use of control system 13230 which may alternatively be used for communication between the hardware nodes 1330 and radio units 13200.

There is also provided a computer program comprising instructions which, when executed by processing circuitry (such as the processing circuitry of the network node described earlier, the processing circuitry of the base station described earlier, and/or the processing circuitry of the UE described earlier), cause the processing circuitry to perform at least part of the method described herein. There is provided a computer program product, embodied on a non-transitory machine-readable medium, comprising instructions which are executable by processing circuitry (such as the processing circuitry of the network node described earlier, the processing circuitry of the base station described earlier, and/or the processing circuitry of the UE described earlier) to cause the processing circuitry to perform at least part of the method described herein. There is provided a computer program product comprising a carrier containing instructions for causing processing circuitry (such as the processing circuitry of the network node described earlier, the processing circuitry of the base station described earlier, and/or the processing circuitry of the UE described earlier) to perform at least part of the method described herein. In some embodiments, the carrier can be any one of an electronic signal, an optical signal, an electromagnetic signal, an electrical signal, a radio signal, a microwave signal, or a computer-readable storage medium.

It will be understood that at least some or all of the method steps described herein can be automated in some embodiments. That is, in some embodiments, at least some or all of the method steps described herein can be performed automatically. The method described herein can be a computer-implemented method.

Therefore, in the manner described herein, there is advantageously provided a technique for use in estimating a total energy consumption of a UE in a network. The technique described herein provides transparency of the energy consumption and optionally also the carbon footprint (or, more specifically, the CO₂ impact). It is likely that a reduction in the energy consumption and/or the carbon footprint (or, more specifically, the CO₂ emissions) for a UE user can be achieved from a UE changing its behaviour, or behaviour patterns. The insights that can be provided by the technique described herein can assist with encouraging (or incentivizing) this change. The technique described herein can provide an advantageous extension to existing power consumption meters to enable the estimation of the effect (in terms of total energy consumption and optionally also the total carbon footprint, e.g. with the associated CO₂ cost) of one or more (e.g. processing) tasks at UE level and also optionally at network level.

It should be noted that the above-mentioned embodiments illustrate rather than limit the idea, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A method for estimating a total energy consumption of a user equipment, UE, in a network, wherein the method is performed by a network node and the method comprises:
estimating a total energy consumption for the UE based on a resource usage for the UE and a measure of energy consumed by a base station of the network serving the UE in communicating with the UE,
wherein the resource usage for the UE is reported to the network node by the UE and/or the base station, and the measure of energy consumed by the base station is reported to the network node by the UE and/or the base station.

2. The method as claimed in claim 1, the method comprising:
initiating rendering, at the UE, of any one or more of:
the resource usage for the UE;
the measure of energy consumed by the base station; and
the estimated total energy consumption for the UE.

3. The method as claimed in claim 2, the method comprising:
initiating rendering, at the UE, of the estimated total energy consumption for the UE with a corresponding total energy consumption for a reference activity that has an associated carbon footprint.

4. The method as claimed in claim 1, the method comprising:
generating a model to predict a future total energy consumption for the UE,
wherein the model is generated using the estimated total energy consumption for the UE, the resource usage for the UE, and the measure of energy consumed by the base station.

5. The method as claimed in claim 4, wherein:
generating the model to predict the future total energy consumption for the UE comprises:
compiling a look-up table to predict the future total energy consumption for the UE; or
training a machine learning model to predict the future total energy consumption for the UE.

6. The method as claimed in claim 1, the method comprising:
estimating a carbon footprint for the UE based on the estimated total energy consumption for the UE.

7. The method as claimed in claim 6, the method comprising:
estimating the carbon footprint for the UE based on the estimated total energy consumption for the UE and an emission factor for one or more energy sources powering the base station.

8. The method as claimed in claim 6, the method comprising:
initiating rendering, at the UE, of the estimated carbon footprint for the UE.

9. The method as claimed in claim 8, the method comprising:
initiating rendering, at the UE, of the estimated carbon footprint for the UE with a carbon footprint for a reference activity.

10. The method as claimed in claim 1, the method comprising:
controlling one or more network orchestrators based on the estimated carbon footprint for the UE; and/or
controlling network slice construction, composition and/or deployment based on the estimated carbon footprint for the UE.

11. The method as claimed in claim 7, the method comprising:
generating a model to predict a future carbon footprint for the UE, wherein the model is generated using the estimated carbon footprint for the UE and the estimated total energy consumption for the UE.

12. The method as claimed in claim 11, wherein:
the model is generated using a predicted emission factor for one or more energy sources powering the base station.

13. The method as claimed in claim 11, wherein:
generating the model to predict the future carbon footprint for the UE comprises:
compiling a look-up table to predict the future carbon footprint for the UE; or
training a machine learning model to predict the future carbon footprint for the UE.

14. The method as claimed in claim 1, the method comprising:
determining an efficiency factor indicative of an efficiency of the base station when serving the UE.

15. The method as claimed in claim 14, wherein:
the efficiency factor is determined based on:
measurement data acquired on the base station during development of the base station and/or testing of the base station; and/or
operational data acquired on the base station during deployment of the base station in the network.

16. The method as claimed in claim 14, wherein:
the efficiency factor is determined using a statistical and/or machine learning process.

17. The method as claimed in claim 1, the method comprising:
estimating changes in the total energy consumption for the UE based on periodic changes in the resource usage for the UE in the network and/or periodic changes in the measure of energy consumed by the base station in communicating with the UE,
wherein the periodic changes in the resource usage for the UE is reported to the network node by the UE and/or the base station, and the periodic changes in the measure of energy consumed by the base station is reported to the network node by the UE and/or the base station.

18. The method as claimed in claim 17, the method comprising:
initiating rendering, at the UE, of the estimated changes in the total energy consumption for the UE.

19. The method as claimed in claim 18, the method comprising:
initiating rendering, at the UE, of the estimated changes in the total energy consumption of the UE with corresponding changes in the total energy consumption for a reference activity that has an associated carbon footprint.

20. The method as claimed in claim 17, the method comprising:
estimating changes in a carbon footprint for the UE based on the estimated changes in the total energy consumption for the UE.

21. The method as claimed in claim 20, the method comprising:
estimating the changes in the carbon footprint for the UE based on the estimated changes in the total energy consumption for the UE and/or changes in an emission factor for the one or more energy sources powering the base station.

22. The method as claimed in claim 20, the method comprising:
initiating rendering, at the UE, of the estimated changes in the carbon footprint for the UE.

23. The method as claimed in claim 22, the method comprising:
initiating rendering, at the UE, of the estimated changes in the carbon footprint for the UE with corresponding changes in a carbon footprint for a reference activity.

24.-27. (canceled)

28. A network node comprising processing circuitry configured to operate in accordance with claim 1.

29.-30. (canceled)

31. A method for use in estimating an energy consumption for a user equipment, UE, in a network, wherein the method is performed by a base station of the network that is serving the UE and the method comprises:
reporting, to a network node, a resource usage for the UE and/or a measure of energy consumed by the base station in communicating with the UE, wherein the resource usage for the UE is for use, with the measure of energy consumed by the base station, in estimating a total energy consumption for the UE.

32.-40. (canceled)

41. A method for use in estimating an energy consumption for a user equipment, UE, in a network, wherein the method is performed by the UE and the method comprises:
reporting, to a network node, a measure of energy consumed by a base station of the network serving the UE in communicating with the UE and/or a resource usage for the UE,
wherein the measure of energy consumed by the base station is for use, with the resource usage for the UE, in estimating a total energy consumption for the UE.

42.-52. (canceled)
